(19) United States
(12) Patent Application Publication
(10) Pub. No.: US 2025/0326031 A1
(43) Pub. Date: Oct. 23, 2025

(54) INSTALLATION FOR APPLYING A LINING COMPOSITION IN THE FORM OF DRY PARTICULATE MATERIAL TO FORM A WORKING LINING ONTO A PERMANENT REFRACTORY LAYER OF A TUNDISH

(71) Applicant: Vesuvius Group, S.A., Ghlin (BE)

(72) Inventor: Georges Stamatakis, Ghlin (BE)

(73) Assignee: Vesuvius Group, S.A., Ghlin (BE)

(21) Appl. No.: 18/868,861

(22) PCT Filed: Jun. 5, 2023
(86) PCT No.: PCT/EP2023/064936

§ 371 Date: Nov. 25, 2024

(30) Foreign Application Priority Data
Jun. 3, 2022 (EP) 22177300.5

(51) Int. Cl. B22D 41/02; C23C 24/08

(52) U.S. Cl. CPC B22D 41/023; C23C 24/082

(57) ABSTRACT

An installation for applying a lining composition in the form of dry particulate material (2p) is provided to form a working lining (2s) onto a surface of a cavity in a tundish (1). A space reference system (X, Y, Z), where X is a longitudinal axis, Y is a transverse axis, and Z is a vertical axis is used. The installation includes a support frame defining a passage, a tank for storing an amount of the dry particulate material, dispensing units, a plunger configured for fitting in the cavity, a longitudinal translation mechanism is configured for holding and translating the dispensing along the longitudinal axis, a transverse translation mechanism is configured for receiving the tundish and translating the tundish along the transverse axis of the passage, and an elevation translation mechanism is configured for holding the plunger and translating the plunger along the vertical axis of the cavity when the tundish is located in the passage.

### TECHNICAL FIELD

The present invention concerns generally to a tundish used in metal forming processes, and specifically to an installation for automatically or semiautomatically applying a working lining onto inner walls of a tundish.

### BACKGROUND OF THE INVENTION

In continuous metal forming processes, metal melt is transferred from one metallurgical vessel to another, to a mould or to a tool. For example, a ladle is filled with metal melt out of a furnace and driven over to a tundish to discharge the molten metal from the ladle, generally through a ladle shroud into the tundish. The metal melt can then be cast through a pouring nozzle from a tundish outlet to a mould or tool for continuously forming slabs, billets, beams, thin slabs, and the like. Flow of metal melt out of the ladle into the tundish and out of the tundish into the mould or tool is driven by gravity. The flow rates can be controlled by sliding gates in fluid communication with an outlet of the ladle or tundish. A ladle sliding gate can be used to control the flow rate out of the ladle and even interrupt the flow at a sealed position. Similarly, a tundish sliding gate can be used to control the flow rate out of the tundish and interrupt the flow in a sealed position. Often, the flow rate out of the tundish is controlled by a stopper instead of a sliding gate.

Since casting of metal into a mould or tool is to run continuously, the tundish plays the role of a buffer and the level of molten metal in the tundish must remain substantially constant during the whole casting operation. The level of molten metal in the tundish, however, drops during the replacement of an empty ladle by a new ladle filled with molten metal. The flow out of the tundish is maintained substantially constant by (1) reducing the time of ladle replacement and (2) controlling the aperture of the tundish outlet by means of the stopper or a slide gate. The surface of the metal melt in the tundish is covered with a layer of slag which protects the metal melt from oxidation and concentrates impurities which could be present in the metal melt. The slag is generally considered as being rather corrosive for the refractory lining.

During continuous casting, a volume of metal is left in the tundish at the end of the casting sequence to prevent slag from flowing into the mould. This volume is referred to as skull and must be removed upon refurbishing the tundish for a new casting operation. The removal of the skull is called deskulling. As the skull generally adheres to the working lining, deskulling can damage the permanent refractory layer in case the adhesion between the working lining and the permanent refractory is too strong. An apparatus for deskulling a tundish is described, e.g., in KR20000030056.

There are two major techniques for applying a working lining (2s) onto the peripheral walls and floor of a tundish: spray lining, and dry vibe lining.

Spray lining consists of spraying an aqueous slurry containing particles and binder. Spraying can be made manually, which is labour intensive, and the reproducibility is not guaranteed, or by a robot, as described e.g., in U.S. Pat. No. 4,908,234, which ensures a better reproducibility and reduces health hazards. The advantage of wet spraying is to allow lining of complex geometries, including tundish furniture already in place, such as weirs, dams, baffles, pouring pads, and the like. The main inconvenience of this technique is that after spraying, water must be removed from the sprayed slurry, which takes time and energy, and the surface quality of the lining is not as smooth as could be wished.

Dry vibe lining uses free flowing powders without addition of water. A “plunger”, sometimes called “mandrel” or “former,” having a geometry matching the geometry of the tundish cavity to be lined, is inserted into the cavity leaving a gap between the plunger and the floor and peripheral walls of the cavity. The gap between the plunger and tundish is filled with free-flowing powder. In some cases, the plunger is configured for vibrating, thus enhancing the flow of the powder. The powder is allowed to set, and the plunger can be removed. Two main types of powder systems are used: cold set powders and heat-set powders.

Cold set powders are mixed with a binder and hardener prior to filling the gap. The lining can cure at room temperature. As their name suggests, heat-set powders require heat to set. The setting temperature can be of the order of 150 to 350° C. and the heat can be provided by heating the plunger or the tundish. WO17187013 describes setting of the working lining using microwave energy. Cold set and heat-set powders are well known in the art and need not be further defined herein. Both cold-set and heat-set compositions can typically contain specific amounts of MgO, Al₂O₃, dolomite, olivine, dunite or a combination thereof. Heat-set compositions can comprise a binder selected among any one of a phenolic resin, a sugar (e.g., glucose or dextrose), sodium silicate, sodium phosphate, boric acid, glass powder, or any combination thereof. Cold-set compositions also have a binder which is generally liquid at room temperature, including e.g., a liquid sodium silicate and a catalyst.

The dry vibe lining technique yields a smoother finish of the working lining which was found to have a beneficial effect on steel quality and to enhance erosion resistance and, hence, service life of the working lining. Because of the absence of water, hydrogen pick up by the steel during casting is reduced. The adhesion between the working lining (2s) and the permanent refractory (3r) is lower than with spraying, ensuring a good deskulling. The main inconvenience is that a given plunger is dedicated to a single tundish geometry. If a metallurgic plant uses tundishes of different geometries, a specific plunger is required for each tundish geometry. Furthermore, the handling of the plunger requires a crane system for inserting the plunger into the cavity and removing it after setting of the working lining.

Embodiments of the present invention primarily concern dry vibe lining techniques only. The gap can be filled with powder manually, by a human operator. This operation is labour intensive, and solutions have been proposed to automate the operation partly or fully.

WO2005009643 describes an apparatus for forming a uniform lining of refractory material within the interior of a coreless furnace, comprising a plunger and a carrier which can be attached to the plunger. The carrier comprises a conical upper surface having an outer diameter substantially equal to the diameter of the lining form. By pouring a particulate refractory material onto said conical upper surface, the particulate refractory material is directed into the gap between the plunger and the furnace. This technique is adapted to furnaces having a substantially cylindrical geometry and is otherwise not suitable for application to tundishes whose geometry is elongated, with length to width aspect ratios (L/W) greater than 2 (L/W>2), generally greater than 3 and even 4 or 5.

WO9918244 describes an installation for filling the gap between the tundish and the plunger with a lining composition in the form of dry particulate material by dropping the particulate material into the gap in a single mass. To this purpose an “installing device” is designed with outlets running along a whole peripheral length of the gap. This solution automates the lining operation, but requires substantial equipment, including the former and a customized installing device is required for each specific tundish geometry,

Similarly, WO2005020264 describes a device for lining a tundish comprising screw conveyors extending along a whole length of the gaps formed along two longitudinal walls of the tundish. The screw conveyors are provided with openings extending along the whole length of the corresponding gaps. This solution does not seem satisfactory for filling the gaps along the transverse walls defining the width of the tundish and further seems restricted to substantially rectangular tundishes. Here again, a customized screw conveyor is typically required for lining each specific tundish geometry.

The solutions available to date for automating lining of a tundish by filling a gap with particulate material are not flexible, in that one installation cannot be used for lining tundishes of different geometries. Besides the plunger, the equipment required to automate the lining too must be dedicated to a specific tundish geometry. There therefore remains a need for an installation for automatically and reproducibly applying a lining composition in the form of dry particulate material in the gap formed between a tundish and a plunger, which is suitable for a variety of tundish geometries. Embodiments of the present invention proposes such installation. These and other advantages are described in detail in the following sections.

### SUMMARY OF THE INVENTION

The appended independent claims define various embodiments of the present invention. The dependent claims define some additional embodiments. In particular, various embodiments of the present invention concern an installation for applying a lining composition in the form of dry particulate material to form a working lining onto a surface of a cavity of a tundish. A 3D space reference system (X, Y, Z) is defined, wherein X is a longitudinal axis, Y is a transverse axis, the longitudinal axis X and the transverse axis Y being non-parallel coplanar axes and defining a horizontal plane (X, Y), and Z is a vertical axis perpendicular to said horizontal plane (X, Y). In this 3D space reference system, the longitudinal axis X and the transverse axis Y are advantageously perpendicular. Alternatively, they can form an angle different from 90°. Such non-perpendicular configuration of longitudinal axis X and transverse axis Y can indeed be of interest, in particular when the installation is configured to apply a lining composition on a tundish having adjacent walls which are non-perpendicular (such as a tundish whose horizontal cross section has a trapezoidal, parallelogram or triangular shape). The tundish has a longitudinal dimension (x1) measured along the longitudinal axis (X), a height (z1) measured along the vertical axis (Z) and a transverse dimension (y1) measured along the transverse axis (Y) and comprises a floor and peripheral walls defining the cavity. The installation comprises a support frame, a tank, one or more dispensing units, a plunger, and longitudinal, transverse, and elevation translation mechanisms for partly or fully automating the coating of the surface of the tundish cavity with the working lining.

The support frame defines a passage of breadth measured along the longitudinal axis (X) greater than the longitudinal dimension (x1) of the tundish, and a height larger than the height (z1) of the tundish.

The tank is configured for storing an amount of the dry particulate material, preferably sufficient to coat the surface of the tundish without having to replenish the tank. The tank comprises a tank outlet coupled to a metering unit configured for metering and conveying a defined amount of dry particulate material to a dispensing outlet,

The one or more dispensing units are equipped with a dispensing head and are configured for being reversibly coupled to the dispensing outlet. The dispensing head comprise one or more openings configured for dispensing dry particulate material metered by the metering unit.

The plunger is configured for fitting in the cavity with a floor gap between the plunger and floor and a peripheral gap of gap width (g) between the plunger and peripheral walls of the tundish corresponding to a desired thickness of the working lining.

The longitudinal translation mechanism is configured for holding and translating the dispensing outlet along the longitudinal axis (X) over a distance greater than or equal to the longitudinal dimension (x1) of the tundish with the dispense outlet located above the height (z1) of the tundish. The transverse translation mechanism is configured for receiving the tundish and translating the tundish along the transverse axis (Y) in and out of the passage. Finally, the elevation translation mechanism is supported by the support frame and is configured for reversibly holding the plunger and translating the plunger along a direction having a component parallel to the vertical axis (Z) in and out of the cavity when the tundish is located in the passage.

In a preferred embodiment of the present invention, the installation comprises a controller configured for controlling and optionally synchronizing, one or more of:
the metering unit,
the longitudinal translation of the dispensing opening by the longitudinal translation mechanism,
the transverse translation of the tundish by the transverse translation mechanism, and
preferably the elevation translation of the plunger by the elevation translation mechanism.
   The synchronization is configured for filling, on the one hand, the floor gap between the plunger and floor and, on the other hand, the peripheral gap between the plunger and peripheral walls of the tundish, when the plunger is in the cavity.

In a preferred embodiment, the installation comprises also a transverse dispensing mechanism configured for translating (Δy) the dispensing outlet along the transverse direction (Y) over a distance at least equal to the transverse dimension (y1) of the tundish.

The metering unit can comprise an Archimedes' screw, comprising an inlet coupled to the tank outlet and an outlet which is the dispensing outlet. The longitudinal translation mechanism is preferably configured for moving the tank and metering unit together with the dispensing outlet.

It is preferred that the installation comprises a rack storing one or more dispensing units equipped with different dispensing heads. For example, the dispensing heads can include a floor dispensing head, comprising one or more openings forming in combination an elongated slit, of length (l) of at least 50% of a width of the floor, and preferably configured for dispensing particulate material to form a bed of particulate material over a whole area of the floor in a single translation either,
a single longitudinal translation (Δx) of the dispensing outlet, when the longitudinal dimension (x1) of the tundish is larger than the transverse dimension (y1) thereof, or
a single transverse translation (Δy) of the tundish (1), when the longitudinal dimension (x1) of the tundish is shorter than the transverse dimension (y1) thereof, or
   a single transverse translation (Δy) of the dispensing outlet (25o), when the installation comprises a transverse dispensing mechanism (31dy) according to claim 5, and when the longitudinal dimension (x1) of the tundish is shorter than the transverse dimension (y1) thereof

The dispensing heads can also comprise a wall dispensing head, comprising an opening having a largest dimension along at least one of the longitudinal and transverse axes (X, Y) not exceeding the gap width (g) of the peripheral gap, and wherein the opening is preferably orientable.

The dispensing unit can comprise a tubular portion having a length that can be varied along an extension direction.

To further automate, preferably to fully automate the coating operation, the installation preferably comprises a robot configured for coupling and decoupling the dispensing unit to and from the dispensing outlet and for preferably selecting one of the one or more dispensing units and removing it from the rack, as well as for storing a dispensing unit into the rack after decoupling it from the dispensing outlet. In a preferred embodiment, the robot, is mounted on a robot translation mechanism, configured for translating the robot along the longitudinal direction (X) or the transverse direction (Y). The translating of the robot is preferably synchronized with translations (Δx, Δy) of the dispensing outlet. The robot can be configured for handling and holding the dispensing unit coupled to the dispensing outlet during the translations (Δx, Δy) of the dispensing outlet.

In one embodiment, the longitudinal translation mechanism (Δx) of the dispensing outlet comprises a tubular portion having a length that can be varied along a component parallel to the longitudinal axis (X), such as for example a telescopic tubular portion, allowing the longitudinal translation of the dispensing outlet over a distance at least equal to the longitudinal dimension (x1) of the tundish, which is herein a width of the tundish, shorter than the transverse dimension (y1) (i.e., x1<y1).

The transverse translation mechanism can comprise two rails extending along the transverse axis (Y) and a carriage mounted on bearings or wheels configured for rolling on the rails and for receiving the tundish. A first centring element is preferably fixed to the carriage and a second centring element (5) is fixed to the tundish. The first and second elements comprise a male element fitting into a female element upon vertically translating the tundish onto the carriage to centre the tundish on the carriage and to ensure repeatability of a position of the tundish relative to the carriage.

The installation can comprise an alignment system ensuring that the plunger fits iin the cavity leaving the peripheral gap of defined gap width (g), wherein the alignment system comprises a first element fixed to the plunger and a second element fixed to the tundish, wherein the first and second elements comprise a male element fitting into a female element upon vertically translating the plunger into the cavity. The plunger can comprise heating elements for accelerating solidification of the particulate material to form the working lining. This is particularly useful for heat-set powders.

The present invention also concerns a method for forming a working lining on a surface of a cavity of a tundish having a longitudinal dimension (x1) measured along the longitudinal axis (X), a height (z1) measured along the vertical axis (Z) and a transverse dimension (y1) measured along the transverse axis (Y) and comprising a floor and peripheral walls defining the cavity, wherein advantageously X⊥Y⊥Z. The method comprises the following steps.
providing an installation as defined supra,
filling the tank with an amount of coating composition in the form of dry particulate material (2p), the dispensing outlet being at a first position (X1) along the longitudinal axis,
loading the plunger onto the elevation translation mechanism and translating (Δz) the plunger along a direction comprising a component parallel to the vertical axis (Z) to a top vertical position (Z0), higher than the height (z1) of the tundish,
loading the tundish onto the transverse translation mechanism and translating (Δy) the tundish along the transverse axis (Y) to a first transverse position (Y1), below and in alignment with the dispensing outlet,
coupling a dispensing unit to the dispensing outlet,
metering the coating composition to feed the dispensing outlet at a controlled flow rate, to dispense the particulate material to thus form a bed of particulate material on a surface of the floor of the cavity by,
   longitudinally translating (Δx) the dispensing outlet along the longitudinal axis (X), or
   transversally translating (Δy) the tundish along the transverse axis (Y), or
   transversally translating (Δy) the dispensing outlet along the transverse axis (Y),
transversally translating (Δy) the tundish along the transverse axis (Y) into the passage, to a second transverse position (Y2), below and in alignment with the plunger,
translating (Δz) the plunger along an elevation direction comprising a component parallel to the vertical axis (Z) to a bottom position (Z1) into the cavity until the plunger rests on the bed of particulate material and forms a peripheral gap of gap width (g) with the peripheral walls of the tundish,
aligning the outlet of a dispensing unit, which can be same as or different from the dispensing unit cited supra, with a point of the peripheral gap,
metering the coating composition to feed the dispensing outlet) at a controlled flow rate to dispense the particulate material, and driving the outlet) of the dispensing unit along a whole perimeter of the peripheral gap to fill the peripheral gap with particulate material, with a synchronized combination of
   a longitudinal translation by longitudinally translating (Δx) the dispensing outlet (25o) along the longitudinal axis (X), and of
   a transverse translation by either,
      transversally translating (Δy) the tundish along the transverse axis (Y), or
      transversally translating (Δy) the dispensing outlet along the transverse axis (Y),
allowing the coating composition thus filling the floor gap and peripheral gap between the plunger and the floor and peripheral walls of the tundish to solidify to form the working lining (2s),
transversally translating (Δy) the tundish along the transverse axis (Y) to the second position (Y2), and
coupling the plunger to the elevation translation mechanism and lifting the plunger up along the elevation direction to the top position (Z0) to remove the plunger from the cavity.

### BRIEF DESCRIPTION OF THE FIGURES

For a fuller understanding of the nature of the present invention, reference is made to the following detailed description taken in conjunction with the accompanying drawings in which:

FIGS. 1 to 12: show (a) a front view and (b) a side view of various steps for lining a tundish by a dry vibe technique according to an embodiment of the present invention.

FIGS. 13(a) and 13(b): show two embodiments of an installation according to an embodiment of the present invention comprising a robot.

FIGS. 14(a) to 14(d): show various embodiments of metering units and of longitudinal translation mechanisms of the dispensing outlet.

FIG. 15(a): shows a plunger and a tundish loaded on a carriage mounted on rails and forming the transverse translation mechanism of the tundish.

FIG. 15(b): shows the plunger inserted in the cavity of the tundish.

FIGS. 15(c) and 15(d): show side and top views of an alignment system between the plunger and the tundish.

FIGS. 16(a) to 16(e): show various embodiments of dispensing units suitable for the present invention.

FIGS. 17 to 23: show seven embodiments of longitudinal and transverse translation mechanisms allowing particulate material to be poured into the peripheral gap over a whole peripheral length of the gap.

FIG. 24: shows an embodiment of dispensing unit comprising a telescopic tubular portion for following the topography of the floor of the tundish.

FIG. 25: shows a top view of an embodiment of the present invention showing how the gap of a tundish having a non-rectangular geometry can be filled automatically with the longitudinal and transverse translation mechanisms of the dispensing outlet.

### DETAILED DESCRIPTION OF THE INVENTION

Embodiments of the present invention provide for an apparatus or installation for automatically and reproducibly applying a lining composition in the form of dry particulate material in the gap formed between a tundish and a plunger, which is suitable for a variety of tundish geometries.

Embodiments of the present invention concern an installation for automatically or semi automatically applying a working lining onto an inner wall of a tundish, by metering a dry particulate material to fill a gap formed between the inner wall and a plunger. The installation can be used to apply the working lining on tundishes having a broad a variety of geometries with a simple reprogramming of the controller and the provision of a plunger having a corresponding geometry. Embodiments of the present invention relate to dry vibe lining techniques.

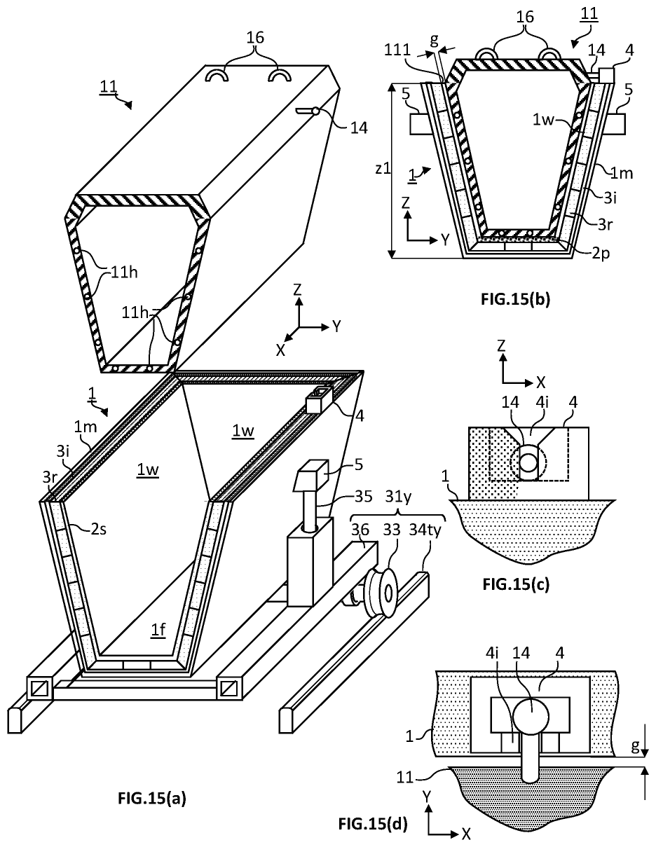

As shown in FIGS. 15(a) and 15(b), a tundish is formed of an outer metal vessel (1m) whose inner walls are lined with insulating and refractory layers (3i,3r). Because the metal melt is at high temperature and, in particular, the slag is aggressive towards the refractory layer (3r), the latter needs be protected to extend their service life. Preformed boards were originally used to this purpose but were soon replaced by the application of a working lining (2s). Working linings may improve the thermal insulation.

Embodiments of the present invention concern an installation for applying a lining composition in the form of dry particulate material (2p) to form a working lining (2s) onto a surface of a cavity of a tundish (1). Because cold set powders generally require the presence of a liquid binder, the expression “dry particulate material” is used herein to refer to particulate material comprising not more than 7 wt. % of water in a liquid form, preferably not more than 5 wt. %. As shown in FIGS. 15(a) and 15(b), the tundish (1) comprises a floor (1f) and peripheral walls (1w) defining the cavity. The surface to be lined can be a part only of the area of the floor (1f) and/or of the peripheral walls (1w), but generally the whole area of the cavity is to be coated with the working lining (2s). The installation comprises,
a support frame (41x-41z),
a tank (21) storing the dry particulate material (2p),
a dispensing unit (22) coupled to the tank (21),
a plunger (11), and
a translation system comprising,
   a longitudinal translation mechanism (31x) for translating the dispensing outlet (25o) along the longitudinal axis (X),
   a transverse translation mechanism (31y) for translating the tundish (1) along the transverse axis (Y), and
   an elevation translation mechanism (31z) for translating the plunger along a direction having a component parallel to the vertical axis (Z), and

The installation can further comprise a controller configured for controlling and synchronizing,
the metering unit (25),
the longitudinal translation of the dispensing outlet (25o) by the longitudinal translation mechanism (31x),
the transverse translation of the tundish (1) by the transverse translation mechanism (31y), and
optionally the elevation translation of the plunger (11) by the elevation translation mechanism (31z)

### TUNDISH (1)

A tundish is an elongated refractory lined vessel defining a cavity formed by peripheral walls (1w) and a floor (1f). A tundish receives metal melt poured from a ladle into an inlet portion of the tundish, generally equipped with a pouring pad (not shown in the Figures), and one or more outlet portions comprising outlets equipped with slide gates or stopper rods for controlling the flow of metal melt out of the tundish into corresponding moulds.

As shown in FIGS. 15(a) and 15(b), the tundish comprises a metal casing (1m) forming a cavity which defines the geometry of the tundish. An insulating layer (3i) is usually applied between the metal casing and a permanent refractory layer (3r) formed of refractory bricks.

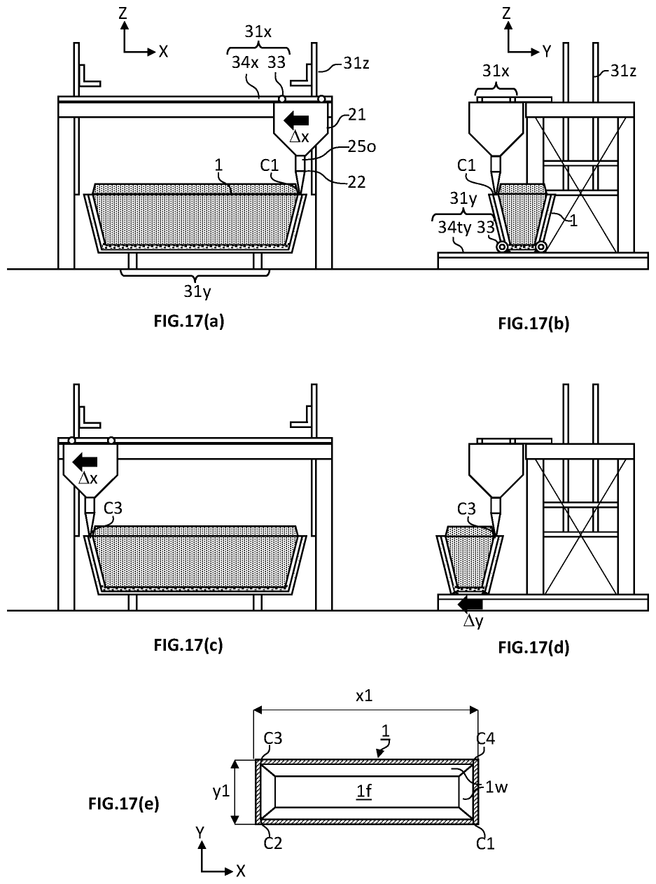

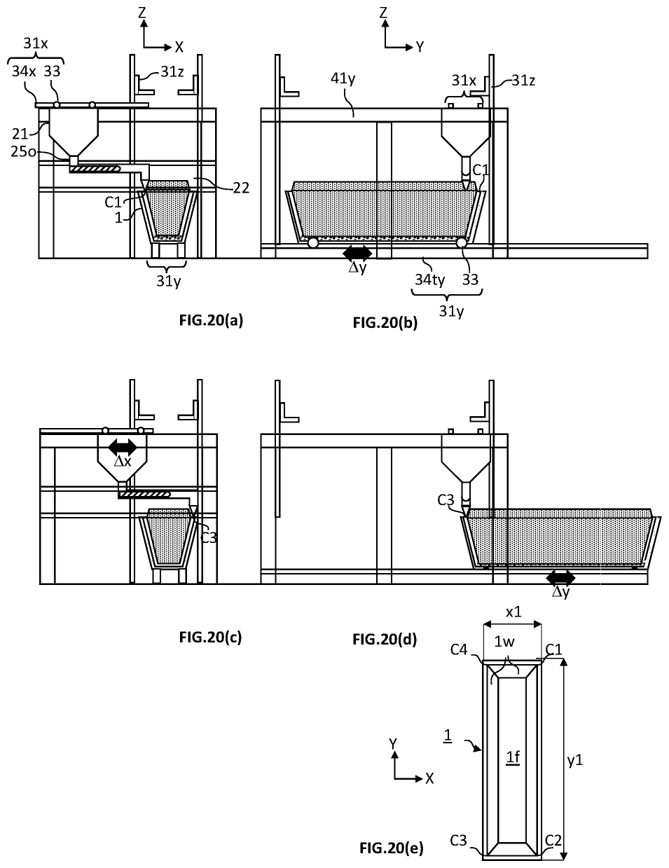

The tundish (1) has a longitudinal dimension (x1) measured along a longitudinal axis (X), a height (z1) measured along a vertical axis (Z) and a transverse dimension (y1) measured along a transverse axis (Y) measured in a 3D space reference system (X, Y, Z), advantageously with X⊥Y⊥Z, wherein X is the longitudinal axis, Y is the transverse axis, and Z is the vertical axis. If the longitudinal dimension (x1) of the tundish is larger than the transverse dimension (y1), then, as shown in FIG. 17(e), the longitudinal dimension (x1) defines a length of the tundish (1) which is aligned with the longitudinal axis (X). Inversely, if the longitudinal dimension (x1) of the tundish is shorter than the transverse dimension (y1), then, as shown in FIG. 20(e), the longitudinal dimension (x1) defines a width of the tundish (1) and the tundish is rotated by 90° relative to the former configuration, to align the length thereof with the transverse axis (Y).

For sake of clarity, most Figures represent a rectangular tundish. But embodiments of the present invention can be used for lining tundishes having more complex geometries as illustrated e.g., in FIG. 25 showing a gable-shaped tundish geometry. Thanks to the translation system described herein, tundishes having any geometry can be automatically processed with the installation of various embodiments of the present invention, by simply controlling the synchronization between longitudinal and transverse translations of the dispensing outlet (25o) and optionally of the tundish (1).

### SUPPORT FRAME (41x-41z)

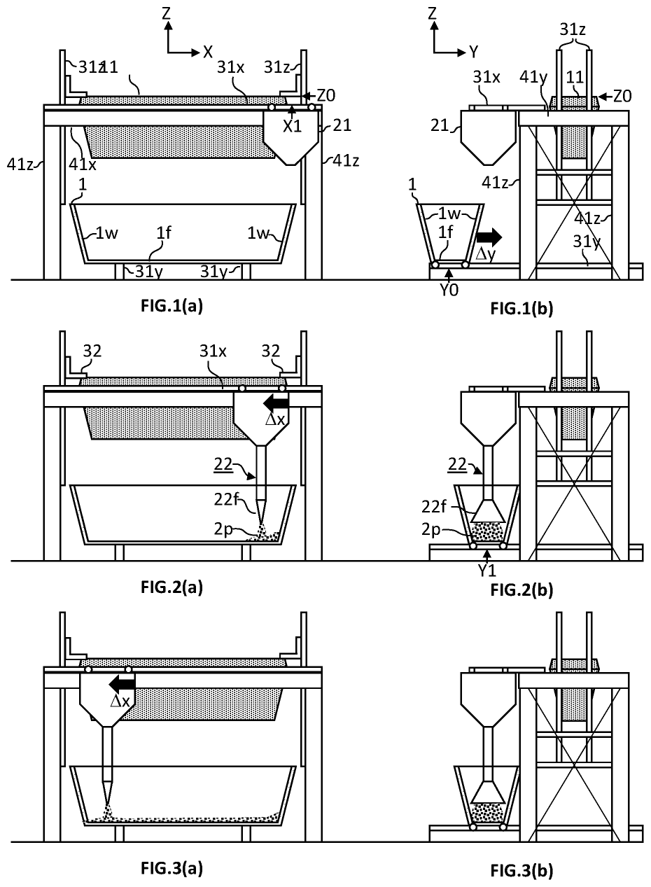

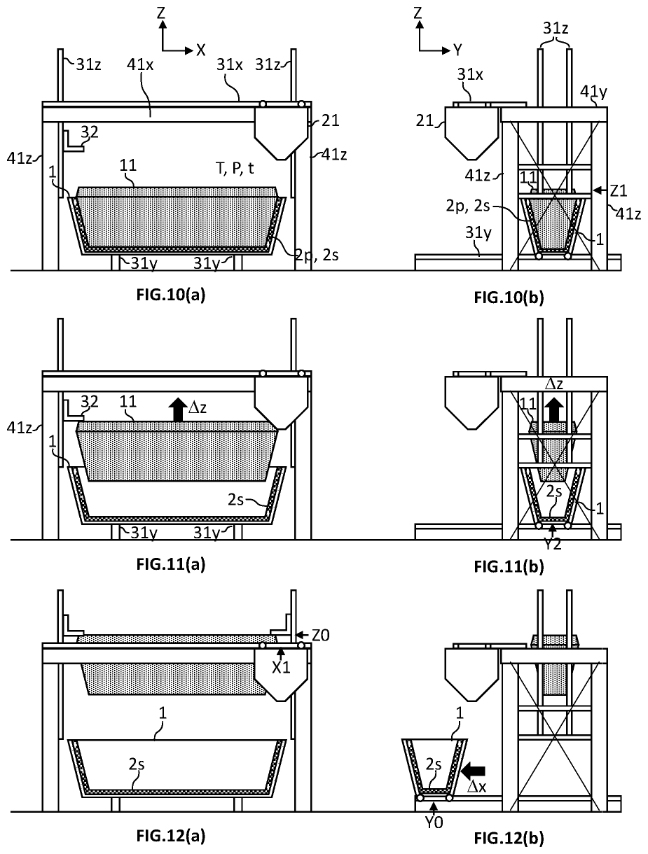

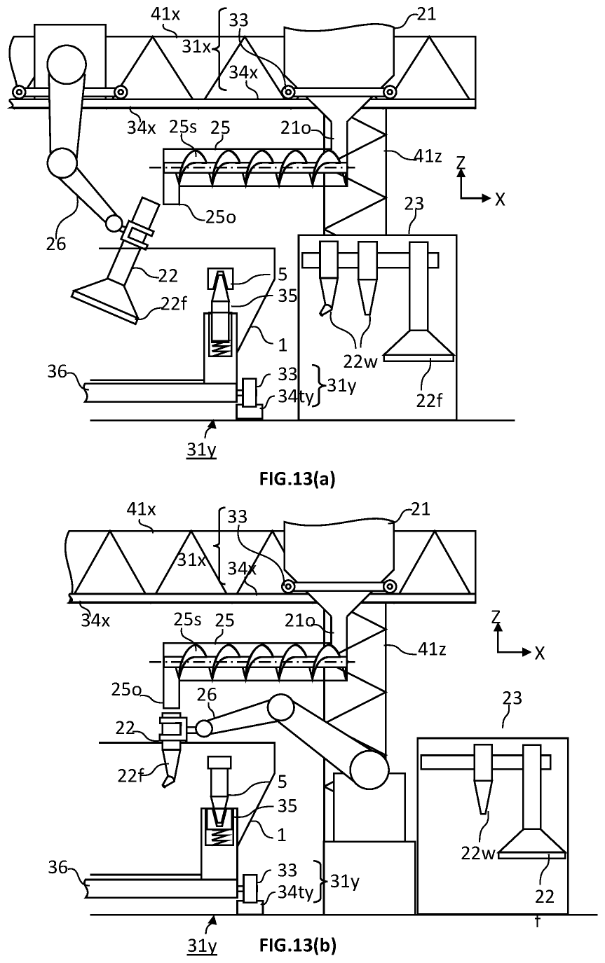

The support frame (41x-41z) defines a passage of breadth measured along the longitudinal axis (X) greater than the longitudinal dimension (x1) of the tundish, and a height larger than the height (z1) of the tundish (1). As shown in FIGS. 1 to 12, the support frame may comprise pillars or girts (41z) for supporting a superstructure. If the translation system comprises elevated rails (33dx) for translating the dispensing outlet (25o) along the longitudinal axis (X) and optionally along the transverse axis (Y) the superstructure may comprise beams or girders configured for supporting the elevated rails (34x, 34dy). FIGS. 1(a), 13(a), 13(b), and 14(a) to 14(c) show a horizontal truss (41x) aligned along the longitudinal axis (X) supporting rails (34x) belonging to the longitudinal translation mechanism (31x). FIGS. 20(b) to 23(b) show horizontal girders or trusses (41y) aligned along the transverse axis (Y) supporting elevated rails (34dy) belonging to a transverse dispensing translation mechanism (31dy) configured for translating (Δy) the dispensing outlet along the transverse direction (Y) and described more in detail in continuation. The girders must be strong enough to support the weight of the tank (21) and optionally of a robot (26) as shown in FIG. 13(a).

The support frame (41x-41z) is also configured for supporting the elevation translation mechanism (31z) for supporting the plunger (11) at a top vertical position (Z0), higher than the height (z1) of the tundish. The breadth of the passage depends on the number of different geometries of tundishes to be processed in a same workshop, as well as on the preferred orientation of the tundish when introducing it through the passage. In a frontal orientation defined by x1>y1, as illustrated in FIG. 17(e), the passage breadth is larger than the length of the tundish (1), whilst in a lateral orientation (i.e., y1>x1) as illustrated in FIG. 20(e), the passage breadth is larger than the width of the tundish (1).

Embodiments of the present invention is not restricted to any specific construction of the support frame, and beams, girders, trusses can be used indifferently, using metal or concrete for the girts. As long as the support frame is suitable for supporting the loads and elevated rails (34x, 34dy) and elevation translation mechanism (31z), then it is suitable for embodiments of the present invention.

### PLUNGER (11)

As illustrated in FIG. 15(b), the plunger (11) is configured for fitting in the cavity of the tundish with a floor gap between the plunger (11) and floor (1f) and a peripheral gap (111) of gap width (g) between the plunger (11) and peripheral walls (1w) of the tundish corresponding to a desired thickness of the working lining (2s). For this reason, a given plunger (11) is generally dedicated to tundishes having a corresponding geometry. It is possible to design plunger modules which can be combined to form different geometries. Embodiments are, however, not restricted by the construction of the plunger, be it modular or not.

The plunger (11) is traditionally made of metal and as shown in FIG. 15(a), is generally hollow with or without an inner reinforcing structure. Plungers can, however, be made of any material, including polymers, especially in case of cold set powder formulations. As shown in FIG. 15(a), the plunger can comprise heating elements (11h) for driving the solidification of heat-set particulate materials (2p) to form the working lining (2s). Since the plunger is raised and lowered along a vertical component by the elevation translation mechanism (31z), it is optionally provided with holding elements (16) as shown in FIGS. 15(a) and 15(b). Rings are shown in these Figures, but it is clear that any other geometry allowing the handling of the plunger (11) by the elevation translation mechanism (31z) can be used in the frame of embodiments of the present invention.

In an advantageous embodiment, an alignment system (4, 14) is provided for aligning the plunger with the cavity leaving the peripheral gap (111) of at least a defined gap width (g). Since the permanent refractory layer (3r) can become locally thinner, e.g., following removal of a spent working layer (2s), the gap thickness (g) can vary locally between two lining operations. The accurate positioning of the plunger ensures that the cavity always has the same dimensions, and that the working lining (2s) always has a thickness of at least a predefined value. As shown in FIGS. 15(a) and 15(b), the alignment system can comprise aligning units, each comprising a first element such as a plunger element (14) fixed to the plunger (11) and a second element such as tundish element (4) fixed to the tundish (1). The first and second elements can interchangeably comprise a male element fitting into a female element upon vertically translating the plunger into the cavity. To ensure a proper alignment, two such aligning units suffice provided at diagonally opposed ends of the plunger (11) and tundish (1). More than two alignment systems can be provided but are not essential.

As shown in FIGS. 15(a), 15(c), and 15(d), the male element, fixed to the plunger in FIG. 15(a), can comprise a rod ended with a free end comprising a protrusion which can be ball shaped or other. The female element: fixed to the tundish in FIG. 15(a), is box shaped with an open surface facing the male element and forming a cavity surrounded by side walls. An aperture (4i) is provided in one side wall to admit the rod of the male element when the plunger is lowered into the cavity. The aperture is optionally funnel shaped to naturally guide the rod and hence the whole plunger to their proper positions.

In some embodiments, the plunger is configured for vibrating when fitted in the cavity of the tundish to enhance the flow of dry powder particles through the peripheral gap (111). In some embodiments, various sensors and/or a vision system can be configured to detect where the plunger is located in the installation: in the elevation translation mechanism (31z), in the tundish (1) or in the transverse translation mechanism (31y). This feature of the installation is of interest when rebooting the various controllers in the installation, for example after an unexpected interruption of the power supply to the installation, such as in the case of a power outage.

### TANK (21) AND METERING UNIT (25)

The installation comprises a tank (21) configured for storing an amount of the dry particulate material (2p). The tank (21) comprises a tank outlet (21o) coupled to a metering unit (25) configured for metering (or dosing) and conveying a defined amount of dry particulate material (2p) to a dispensing outlet (25o).

The tank is optionally supported by the supporting frame such that the tank outlet (21o) and dispensing outlet (25o) be located higher than the tundish relative to the vertical axis (Z) so that gravity can assist or even drive the dispensing of the dry particulate material.

The dispensing outlet (25o) is coupled to the longitudinal translation mechanism (31x). In one embodiment, illustrated in FIGS. 1 to 13, 14(a) to 14(c), and 17 to 20; the longitudinal translation mechanism (31x) comprises rails (34x) extending along the longitudinal axis (X) and the tank (21) is mounted on bearings or wheels (33) or the like so that the tank (21) can translate together with the dispensing outlet along the longitudinal axis (X).

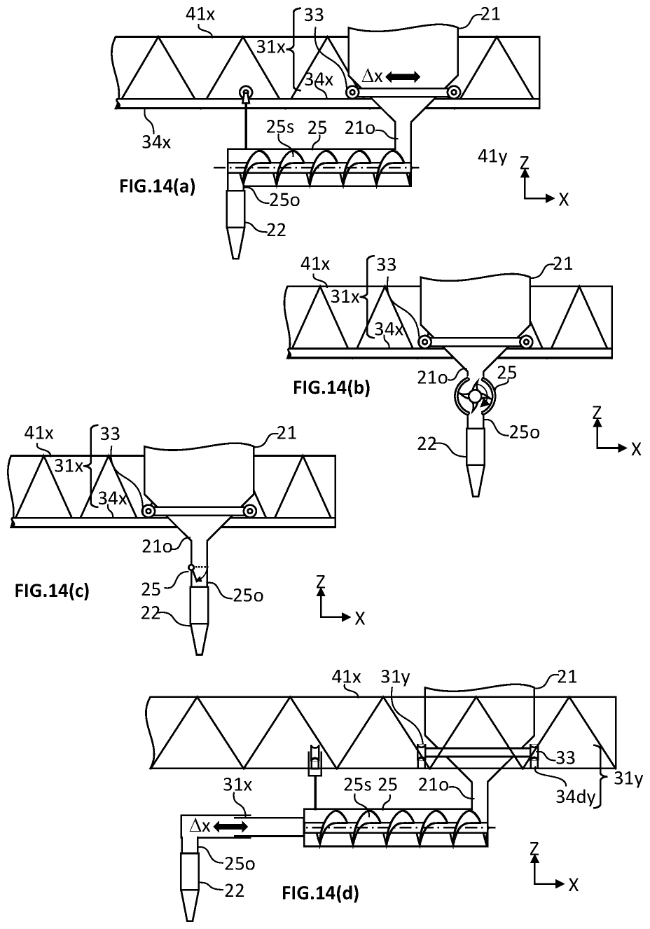

In an alternative embodiment, illustrated in FIGS. 14(d), 21 and 22, the tank (21) cannot translate along the longitudinal axis (X), and a tubular portion having a length that can be varied, such as a telescopic tubular portion is provided between the tank outlet (21o) and the dispensing outlet (25o) allowing the longitudinal translation of the dispensing outlet (25o) over a distance at least equal to the longitudinal dimension (x1) of the tundish. This embodiment is particularly suited when the tundish is presented to the installation in the lateral orientation, namely when the longitudinal dimension (x1) defines a width of the tundish, which is shorter than the transverse dimension (y1) defining a length of the tundish (i.e., y1>x1).

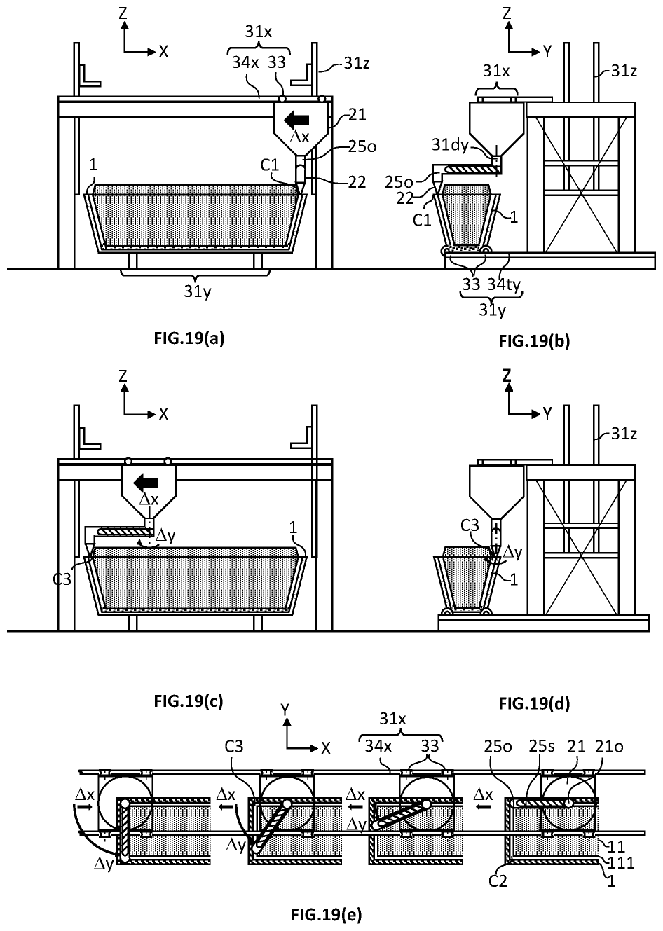

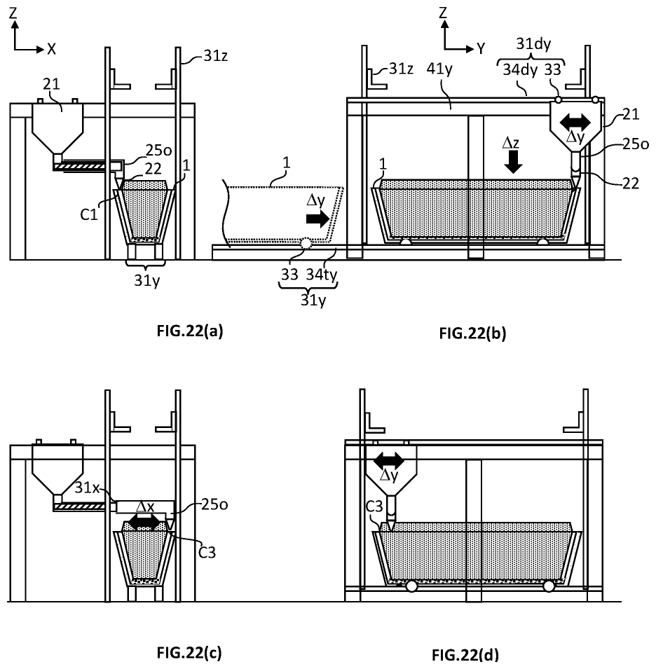

In an advantageous embodiment, the dispensing outlet (25o) is also coupled to a dispensing transverse translation mechanism (31dy). Like the longitudinal translation mechanism (31x) discussed supra, the dispensing transverse translation mechanism (31dy) can also comprise either bearings or wheels (33) and rails (34dy) or a tubular portion having a varying length, herein referred to as a vario-length tubular portion, including for example a telescopic tubular portion or a bellow. It can also comprise a rotation of the dispensing outlet (25o) about the tank outlet (21o) as shown in FIGS. 19, 23 and 25. Both longitudinal and dispensing transverse translation mechanisms (31x, 31dy) can comprise rails (34x, 34dy) but, for sake of simplicity, it is advantageous to combine a rails/wheel translation system for one of the longitudinal and dispensing transverse translation mechanisms (31x, 31dy), optionally the one running along the lengths of the tundish (1), and a vario-length tubular portion for the other translation mechanism, optionally the one running along the widths of the tundish, as shown in FIGS. 14(d) and 22 or a rotating dispensing outlet (25o) as shown in FIGS. 19, 23, and 25.

FIGS. 14(a) to 14(d) illustrate different embodiments of metering units (25). FIGS. 14(a) and 14(d) illustrate a metering unit (25) comprising an Archimedes' screw (25s), comprising an inlet coupled to the tank outlet (21o) and an outlet which is the dispensing outlet (25o). This embodiment is advantageous because it allows offsetting the dispensing outlet (25o) relative to the tank outlet (21o). As shown in FIG. 14(d), it is also suitable for providing a vario-length tubular portion downstream of the Archimedes' screw (25s) for translating longitudinally or transversally the dispensing outlet (25o) as discussed supra.

FIG. 14(b) shows an alternative metering unit (25) comprising rotating vanes, like in a vane pump. This embodiment is very compact and yet allows a very accurate metering of the dry powder material (2p). FIG. 14(c) shows yet a simpler embodiment, wherein the metering unit (25) comprises a valve. The flow rate is varied by controlling the opening of the valve. This system is very simple but prone to clogging and does not afford as accurate a metering than the Archimedes' screw (25s) or the rotating vanes discussed supra.

As shown in FIGS. 19(e), 23(e), and 25, when the tank outlet (21o) and the dispensing opening (25o) are offset on a plane (X, Y), the dispensing outlet (25o) can be rotatable about a vertical axis (Z) advantageously passing through the tank outlet (21o). The rotation of the dispensing outlet (25o) about the vertical axis can contribute to the translation of the dispensing outlet (25o) along the longitudinal or transverse axis (X, Y).

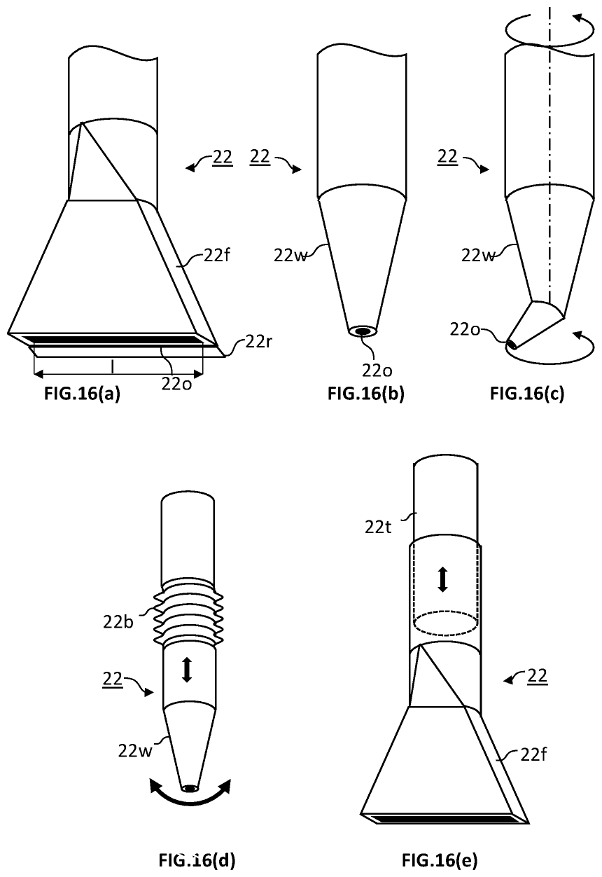

The dispensing unit (22), defined more in detail in continuation, is coupled to the dispensing outlet (25o) and, in some embodiments, can rotate about a vertical axis (Z) passing through the dispensing outlet (25o). This is particularly advantageous for dispensing units (22) having an opening offset with respect to the dispensing outlet as the spout illustrated in FIG. 16(c), to orient the opening thereof towards the peripheral gap (111) as the dispensing outlet (25o) is translated relative to the tundish (1). In case of a rotary coupling between the dispensing outlet (25o) and the dispensing unit (22), the necessary mechanical drive and actuator can be integrated to the dispensing outlet (25o) in that they are not dismounted from the dispensing outlet (25o) when uncoupling the dispensing unit (22) from the dispensing outlet (25o). Alternatively, the necessary mechanical drive and actuator can be integrated in the dispensing unit (22) in that they are an integral part of the dispensing unit (22) and are therefore dismounted from the dispensing outlet (25o) while uncoupling the dispensing unit (22).

### DISPENSING UNIT (22)

The installation comprises one or more dispensing units (22) equipped with a dispensing head (22f, 22w) and configured for being reversibly coupled to the dispensing outlet (25o). The dispensing unit (22) comprises a tubular portion coupled at one end to the dispensing outlet (25o) and at the other end to the dispensing head (22f, 22w). The tubular portion is optionally substantially cylindrical and extends substantially vertically along the vertical axis (Z). A deviation from verticality of the tubular portion is not excluded, but in most cases, a vertical orientation is advantageous to profit from gravity for dispensing the particulate material.

The dispensing head comprises one or more openings (22o) configured for dispensing dry particulate material metered by the metering unit (25). In particular, the dispensing unit (22) can be equipped with a floor dispensing head (22f) designed for pouring dry particulate material (2p) onto the floor (1f) of the tundish, or with a wall dispensing head (22w) configured for pouring the dry particulate material (2p) into the peripheral gap (111) defined between the plunger (11) and the peripheral walls (1w) of the tundish (1).

As illustrated in FIGS. 16(a) and 16(e), the floor dispensing head (22f) can comprise one or more openings (22o) forming in combination an elongated slit, of length (l) of at least 50% of a width of the floor (1f) or even at least 75%, or advantageously close to or equal to 100% of the width of the floor (1f). The floor dispensing head (22f) can combine a substantially cylindrical geometry for coupling to the tubular portion, flaring out in the direction of the width of the floor (1f) of the tundish and thinning in the direction of the length thereof. The one or more openings (22o) are optionally configured for dispensing particulate material (2p) to form a bed of particulate material of desired thickness over a whole area of the floor (1f) in one or more of the following translations,
one or more longitudinal translation (Δx) of the dispensing outlet (25o), when the longitudinal dimension (x1) of the tundish is larger than the transverse dimension (y1) thereof defining a frontal orientation as illustrated in FIG. 17(e) (i.e., x1>y1), or
one or more transverse translation (Δy) of the tundish (1), when the longitudinal dimension (x1) of the tundish is shorter than the transverse dimension (y1) thereof, defining a lateral orientation as illustrated in FIG. 20(e) (i.e., y1>x1), or
one or more transverse translation (Δy) or pass of the dispensing outlet (25o), when the installation comprises a transverse dispensing mechanism (31dy), and when the longitudinal dimension (x1) of the tundish is shorter than the transverse dimension (y1) thereof, defining the lateral orientation as illustrated in FIG. 20(e) (i.e., y1>x1).

Alternatively, two or three passes can be required to deposit the bed of particulate material of desired thickness over a whole area of the floor (1f).

To level the bed of particulate material poured through the floor dispensing head (22f), the latter can be provided with a raking element (22r) acting as a doctor blade downstream of the opening (22o) relative to the displacement direction of the dispensing outlet (25o) relative to the tundish floor (1f). The raking element (22r) can be a rigid or flexible blade, with a free edge which can be smooth or toothed to form furrows like in a ploughed field.

As illustrated in FIGS. 16(b) to 16(d), the wall dispensing head (22w) can comprise an opening (22o) having a largest dimension along at least one of the longitudinal and transverse axes (X, Y) not exceeding the gap width (g) of the peripheral gap (111). As shown in FIG. 16(b), the opening (22o) can be coaxial with the tubular portion of the dispensing unit (22) and optionally substantially parallel to the vertical axis (Z). In an advantageous embodiment illustrated in FIG. 16(c), the opening forms a spout offset from the vertical axis (Z) of the tubular portion of the dispensing unit (22). This allows an easier and more accurate positioning of the opening (22o) over the peripheral gap (111) taking account of the hindrance that the plunger can create. By rotating the dispensing unit (22) or part thereof about a vertical axis (Z) coaxial with the tubular part thereof, the orientation of the spout can be varied easily and precisely. In an alternative embodiment, illustrated in FIG. 16(d), the opening (22o) of the dispensing unit (22) is orientable, e.g., with a bellow (22b).

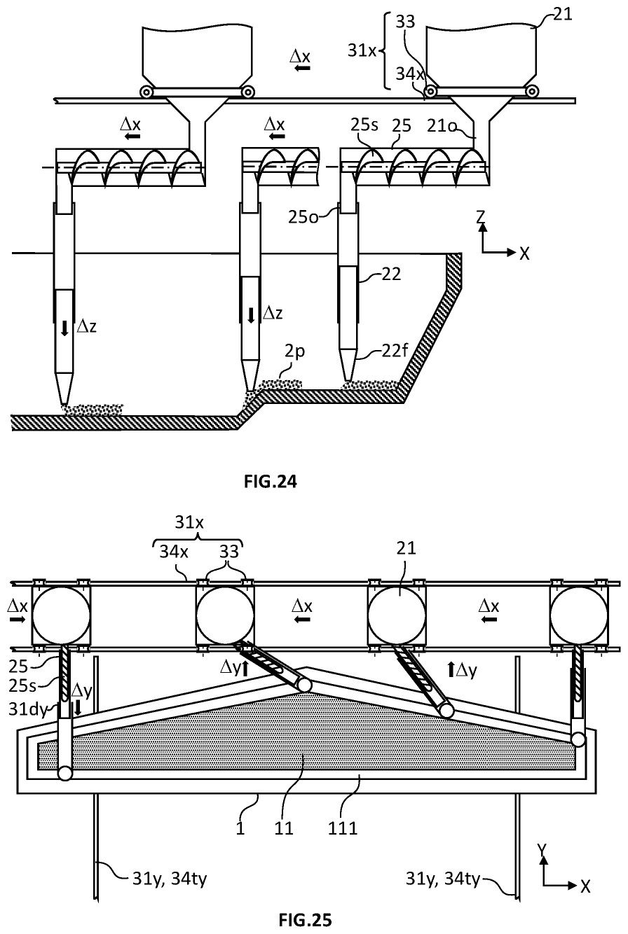

The floor (1f) and, to a lesser extent, the peripheral edges of the tundish (1) are not necessarily flat, as shown e.g., in FIG. 24, showing a tundish whose floor (1f) comprises a step between two substantially flat sections. In order to maintain the opening (22o) of the floor dispensing head (22f) at a substantially constant distance from the floor (1f); the dispensing unit (22) can comprise a mechanism configured for varying the length of the tubular portion thereof along an extension direction comprising a component parallel to the vertical axis (Z). The length of the tubular portion can be varied by, e.g., including a telescopic system, with a fixed tubular section coupled to the dispensing opening (25o) and a moving tubular portion coupled to the dispensing head, as shown in FIGS. 16(e) and 24. Alternatively, the moving tubular section can be coupled to the fixed tubular portion via a bellow (22b) as shown in FIG. 16(d). The movement of the moving tubular portion can be controlled by a motor or by a robot (26) holding the dispensing unit (22) and following it during its displacements.

The dispensing unit (22) can be rigidly fixed to the dispensing opening (25o) by a fixing fixture. Alternatively, it can be held in the coupled position by a robot (26), discussed in continuation.

Different dispensing units (22) with tubular portions of different lengths and with different dispensing heads (22f, 22w) can be stored in a rack (23) ready for use, as shown in FIGS. 13(a) and 13(b).

### TRANSVERSE TRANSLATION MECHANISM (31y)

The transverse translation mechanism (31y) is configured for receiving the tundish (1) and translating the tundish (1) along the transverse axis (Y) in and out of the passage, The transverse translation mechanism (31y) can be useful for allowing the dispensing unit (22) to follow the whole perimeter of the peripheral gap (111) but it is not necessarily the case. In the simplest form, the transverse translation mechanism (31y) is configured for transversally translating the tundish (1) from a loading position (Y0) separate from the support frame into the passage, to a second transverse position (Y2), below and in alignment with the plunger (11). In some embodiments, the transverse translation mechanism (31y) is also configured for transversally translating the tundish to a first transverse position (Y1), below and in alignment with the dispensing outlet (25o) before translating it to the second position (Y2). In yet some embodiments, the transverse translation mechanism (31y) can contribute to the transverse component of the relative movement of the dispensing outlet (25o) and the peripheral gap (111).

As shown in FIG. 15(a), the transverse translation mechanism (31y) optionally comprises a carriage (36) mounted either on wheels (33) or on bearings resting on rails (34ty) extending along the transverse axis (Y). The transverse translation mechanism (31y) could alternatively comprise roller or ball bearings, or a conveying band, or the like. The carriage can be motorized or coupled to a chain or cable system for driving the transverse translation thereof. To ensure a reproducible positioning of the tundish on the carriage centring elements (35) can be fixed at different points of the carriage and second centring elements (5) can be fixed to corresponding points of the tundish. For example, for a rectangular tundish, four second centring elements (5) can be distributed close to the four corners of the tundish (1). Any other configuration ensuring a reproducible positioning of the plunger in the cavity can be applied. The first and second elements comprise a male element fitting into a female element upon vertically translating the tundish onto the carriage (36) to centre the tundish on the carriage (36) and to ensure repeatability of a position of the tundish relative to the carriage (36). In FIGS. 13(a), 13(b), and 15(a) the first centring element (35) is the male element formed by a rod. It is optionally mounted on a suspension system damping any vibration of the tundish. This is particularly advantageous if the plunger can vibrate. For an accurate positioning of the tundish at the different transverse positions (Y0, Y1, Y2), the transverse translation mechanism (31y) can comprise a positioning system configured to determine the position of the tundish (1) and/or of moving parts of the translation mechanism, such as the carriage (36), relative to a fixed frame of reference associated with the support frame (41x-41z). Such positioning system can comprise various kinds of sensors, such as feedback sensors mounted in the mechanical drive of the transverse translation mechanism or alternatively electromagnetic or ultrasonic range finding sensors configured to directly measure the position of the tundish (1) or of the carriage (36) relative to the fixed frame of reference.

Electromagnetic range finding sensors include optical sensors such as laser rangefinders, lidars, and 3D cameras based on laser triangulation, time-of-flight, structured light or computer stereo vision techniques. More broadly, such sensors can also be configured to implement a machine vision technology for monitoring and automatically controlling the operations of the transverse translation mechanism (31y). Besides being configured for receiving the tundish (1) and translating the tundish (1) along the transverse axis (Y) in and out of the passage, the transverse translation mechanism (31y) can also be configured for receiving the plunger (11) independently of the tundish (1). Such feature of the transverse translation mechanism (31y) is advantageous to be able to translate the plunger (11) along the transverse axis (Y) in and out of the passage, without being fitted in the cavity of the tundish (1), such that various maintenance and/or cleaning operations can be performed on the plunger (11).

### ELEVATION TRANSLATION MECHANISM (31z)

The elevation translation mechanism (31z) is supported by the support frame and is configured for reversibly holding the plunger (11) and translating the plunger along a direction having a component parallel to the vertical axis (Z) in and out of the cavity when the tundish is in the passage. The elevation translation mechanism (31z) is so dimensioned as to support the weight of the plunger (11) and to hold it at a top vertical position (Z0), higher than the height (z1) of the tundish until it is inserted into the cavity of the tundish (1). It is also so configured as to remove the plunger from the cavity when the working lining (2s) as set.

The elevation translation mechanism (31z) is provided with gripping elements configured for gripping the holding elements (16) of the plunger (11) to translate the plunger vertically and to hold the plunger at the top vertical position (Z0). In embodiments wherein the tundish is to be transversally translated when the plunger is positioned in the cavity, the gripping elements are also configured for releasing the holding element (16) when the plunger rests on the dry particulate material (2p) covering the floor (1f) of the tundish.

Any elevation translation mechanism (31z) suitable for performing the foregoing tasks is suitable for the embodiments of the present invention. Furthermore, various sensors, such as feedback sensors mounted in the mechanical drive of the elevation translation mechanism (31z), or alternatively range finding sensors, can be configured to determine the vertical position of the plunger (11) translated by the elevation translation mechanism (31z).

### LONGITUDINAL TRANSLATION MECHANISM (31x)

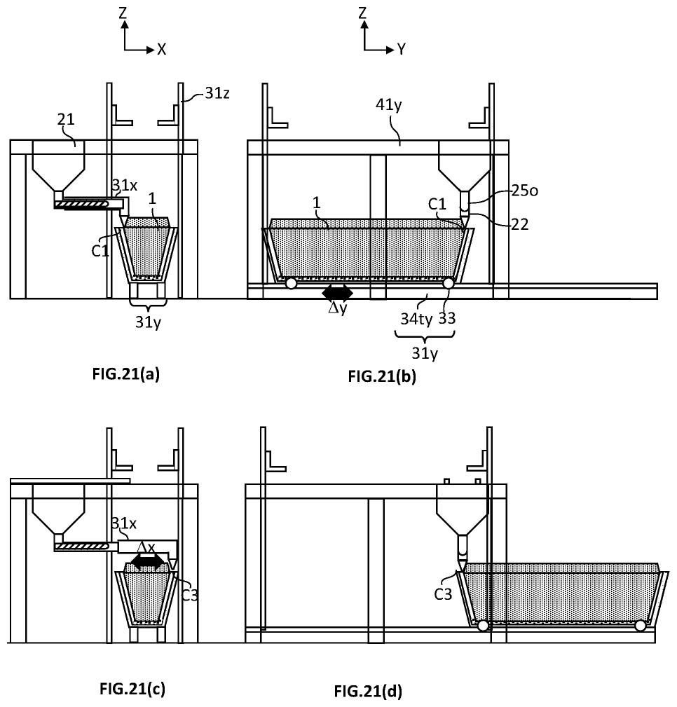

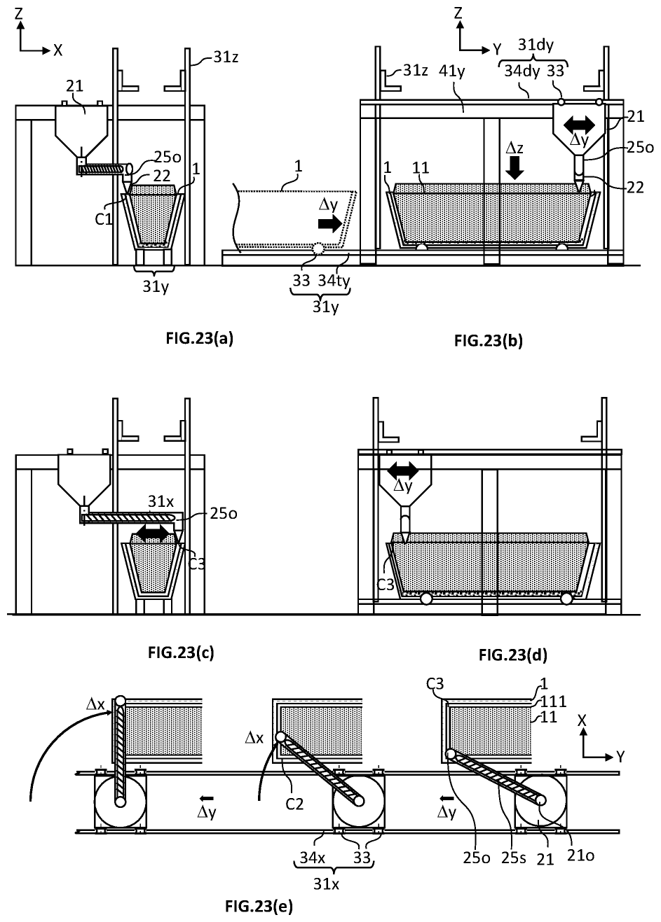

The longitudinal translation mechanism (31x) is configured for holding and translating the dispensing outlet (25o) along the longitudinal axis (X) over a distance greater than or equal to the longitudinal dimension (x1) of the tundish (1), with the dispense outlet (25o) located above the height (z1) of the tundish (1). The longitudinal translation mechanism (31x) is independent of the transverse and elevation translation mechanisms (31y, 31z). The longitudinal translation mechanism (31x) can comprise one of the following systems. In all cases, the tank is maintained above the tundish, along the vertical axis (Z) to profit of gravity to assist dispensing.
the tank (21) is mounted on bearings or wheels (33) rolling on rails (34x) extending along the longitudinal axis (X), as illustrated in FIGS. 1 to 13, 14(a) to 14(c), 17 to 20, and 24, or
a vario-length tubular portion, such as, e.g., a telescopic tubular portion extends along the longitudinal axis (X) between the tank outlet (21o) and the dispensing outlet (25o). Because the length to width aspect ratio (L/W) of tundishes is greater than 2 (L/W>2), generally greater than 3 and even 4 or 5, this embodiment is advantageous when the longitudinal dimension (x1) of the tundish is shorter than the transverse dimension (y1) (i.e., x1=width<y1=length). This embodiment is illustrated in FIGS. 21 and 22, or the dispensing outlet (25o) and the tank outlet (21o) are offset on a plane (X, Y), and the dispensing outlet can rotate about a vertical axis (Z) advantageously passing through the tank outlet (21o), as illustrated in FIG. 23. As for the vario-lentgh tubular portion, this embodiment is advantageous when the longitudinal dimension (x1) of the tundish is shorter than the transverse dimension (y1) (i.e., x1=width<y1 32 length), or
a combination of two or three of the three foregoing systems, as shown in FIG. 25.

The longitudinal translation mechanism (31x) optionally comprises a system based on bearings or wheels (33) rolling on rails (34x) extending along the longitudinal axis (X) when the tundish is presented with the frontal orientation, wherein the longitudinal dimensions (x1) is the 1ength of the tundish and the transverse dimension (y1) is the width of the tundish, with x1>y1, as shown in FIGS. 17 to 19.

The longitudinal translation mechanism (31x) optionally comprises a system based on a telescopic or a rotating tubular portion, or combination of the two when the tundish is presented with a lateral orientation, wherein the longitudinal dimensions (x1) is the width of the tundish and the transverse dimension (y1) is the length of the tundish, with y1>x1, as shown in FIGS. 20 to 22.

For an accurate positioning of the dispensing outlet (25o) along the longitudinal direction of the tundish (1), the longitudinal translation mechanism (31x) can comprise a positioning system configured to determine the position of the dispensing outlet (25o) along the longitudinal axis (X) relative to a frame of reference associated with the tundish (1) or the support frame (41x-41z). Such positioning system can comprise various kinds of sensors, such as feedback sensors mounted in the mechanical drive of the longitudinal translation mechanism (31x) or alternatively electromagnetic or ultrasonic range finding sensors configured to directly measure the position of the dispensing outlet (25o) relative to the frame of reference associated with the tundish (1) or the support frame (41x-41z). Electromagnetic range finding sensors include optical sensors such as laser rangefinders, lidars, and 3D cameras based on laser triangulation, time-of-flight, structured light or computer stereo vision techniques. More broadly, such sensors can also be configured to implement a machine vision technology for monitoring and automatically controlling the operations of the longitudinal translation mechanism (31x).

### DISPENSING TRANSVERSE TRANSLATION MECHANISM (31dy)

The installation can comprise a dispensing transverse translation mechanism (31dy) configured for translating (Δy) the dispensing outlet (25o) along the transverse direction (Y) over a distance at least equal to the transverse dimension (y1) of the tundish (1). The dispensing transverse translation mechanism (31dy) is not essential but can be useful to limit the transverse translations of the tundish (1), which because of its weight, is more difficult to translate than the dispensing opening (25o) coupled to the tank (21).

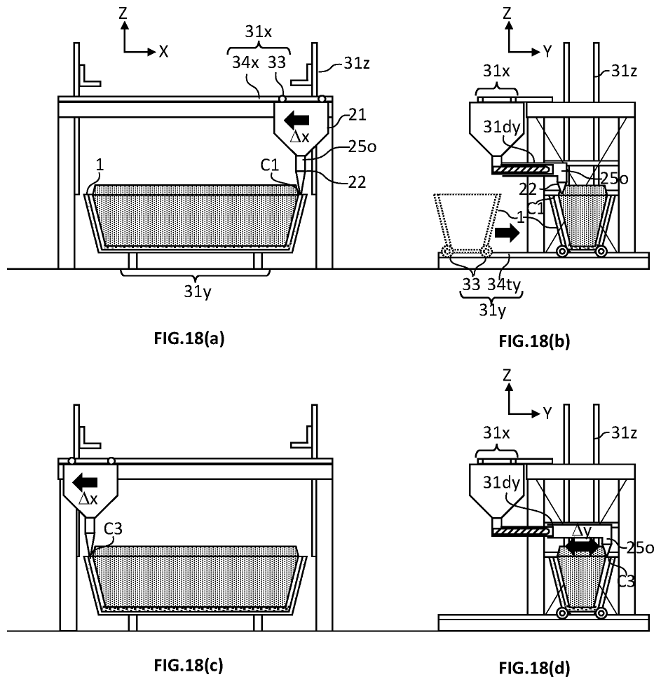

As for the longitudinal translation mechanism (31x), the dispensing transverse translation mechanism (31dy) can comprise one of the following systems,
the tank (21) is mounted on bearings or wheels (33) rolling on rails (34dy) extending along the transverse axis (Y), as illustrated in FIGS. 22 and 23, or
a vario-length (e.g., telescopic) tubular portion extends along the transverse axis (Y) between the tank outlet (21o) and the dispensing outlet (25o). This embodiment is advantageous when the transverse dimension (y1) of the tundish is shorter than the longitudinal dimension (y1), with x1>y1 (i.e., y1=width and x1=length). This embodiment is illustrated in FIG. 18, or
the dispensing outlet (25o) and the tank outlet (21o) are offset on a plane (X, Y), and the dispensing outlet can rotate about a vertical axis (Z) advantageously passing through the tank outlet (21o), as illustrated in FIG. 19. As for the vario-length (e.g., telescopic) tubular portion, this embodiment is advantageous when the transverse dimension (y1) of the tundish is shorter than the longitudinal dimension (x1), with x1>y1 (i.e., y1=width and x1=length), or
a combination of two or three of the three foregoing systems, as shown in FIG. 25.

It is advantageous to avoid having the tank (21) mounted on bearings or wheels (33) rolling on rails for both longitudinal and dispensing transverse translation mechanisms (31x, 31dy) for sake of simplifying the design of the installation. The system based on bearings or wheels (33) rolling on rails has a larger span than any of the telescopic or rotating tubular portion. For this reason, if the installation comprises a dispensing transverse translation mechanism (31dy), it is advantageous that the rails (34x, 34dy) be provided along the direction of the length of the tundish, i.e., along the longitudinal axis (X) for the longitudinal translation mechanisms (31x) if the longitudinal dimension (x1) is the length of the tundish, with x1>y1 and, inversely, along the transverse axis (Y) for the dispensing transverse translation mechanisms (31dy) if the transverse dimension (y1) is the length of the tundish with y1>x1.

A vario-length (e.g., telescopic) or rotating tubular portion is optionally adapted to span over the width of the tundish (1). To summarize, if the installation comprises a dispensing transverse translation mechanism (31dy) an advantageous configuration is as follows,
If x1>y1 (=frontal orientation), then, as shown in FIGS. 17 to 19,
   the longitudinal translation mechanism (31x) comprises a system based on bearings or wheels (33) rolling on rails (34x) parallel to the longitudinal axis (X) to longitudinally translate the tank (21) and the dispensing opening (25o) over the length of the tundish (1) and
   the dispensing transverse translation mechanism (31dy) comprises a system based on a vario-length (e.g., telescopic) and/or a rotating tubular portion to transversally translate the dispensing opening over the width of the tundish.
If y1>x1 (=lateral orientation), then, as shown in FIGS. 22 and 23,
   the longitudinal translation mechanism (31x) comprises a system based on a vario-length (e.g., telescopic) and/or a rotating tubular portion to transversally translate the dispensing opening over the width of the tundish and
   the dispensing transverse translation mechanism (31dy) comprises a system based on bearings or wheels (33) rolling on rails (34dy) parallel to the transverse axis (Y) to transversally translate the tank (21) and the dispensing opening (25o) over the length of the tundish (1).
      For an accurate positioning of the dispensing outlet (25o) along the transverse direction of the tundish, the dispensing transverse translation mechanism (31dy) can comprise a positioning system configured to determine the position of the dispensing outlet (25o) along the transverse axis (Y) relative to a frame of reference associated with the tundish (1) or the support frame (41x-41z). Such positioning system can comprise various kinds of sensors, such as feedback sensors mounted in the mechanical drive of the dispensing transverse translation mechanism (31dy) or alternatively electromagnetic or ultrasonic range finding sensors configured to directly measure the position of the dispensing outlet (25o) relative to the frame of reference associated with the tundish (1) or the support frame (41x-41z). Electromagnetic range finding sensors include optical sensors such as laser rangefinders, lidars, and 3D cameras based on laser triangulation, time-of-flight, structured light or computer stereo vision techniques. More broadly, such sensors can also be configured to implement a machine vision technology for monitoring and automatically controlling the operations of the dispensing transverse translation (31dy).

### ROBOT (26)

As illustrated in FIG. 13, the installation can comprise a robot (26) to fully automate the tundish lining operation. The robot (26) can be configured for coupling and decoupling the dispensing unit (22) to and from the dispensing outlet (25o). The installation can comprise a rack (23) storing at least two dispensing units (22) of different types with tubular portions of different lengths, and/or with different dispensing heads (22f, 22w). The robot is optionally configured for selecting one of the one or more dispensing units (22) and removing it from the rack (23), as well as for storing a dispensing unit (22) into the rack (23) after decoupling it from the dispensing outlet (25o).

As shown in FIG. 13(a), in an advantageous embodiment, the robot (26), is mounted on a robot translation mechanism configured for translating the robot (26). The robot translation mechanism is optionally supported by the supporting frame (41x-41z) and, further optionally mounted on rails. The robot (26) translation is optionally synchronized with the movements of the dispensing opening (25o) and dispensing unit (22) which is coupled to the former. This way, the robot (26) can hold the dispensing unit (22) in a coupled position with the dispensing outlet (25o) during any motion of the dispensing outlet (25o). The robot can be mounted on the same rails (34x, 34dy) as the tank (21) in case the longitudinal or dispensing transverse translation mechanisms (31x, 31dy) comprise rails. Advantageously, a safety system to prevent collisions between the robot (26) and any of the translation mechanisms (31x, 31dy) can be implemented. Such safety system can for example make use of a rangefinder to measure the distance between some reference points on the robot and on the translation mechanism and trigger an emergency stop of the translation mechanism at fault in case the distance falls below a threshold value. To perform its various tasks, the robot can be assisted by a machine vision system. Such machine vision system can be based on data collected by different kinds of sensors, such as one or more of the following: 2D cameras, 3D cameras, lidars, laser rangefinders, ultrasound rangefinders.

Holding the dispensing unit (22) in a coupled position with the dispensing outlet (25o) as the latter moves by means of the robot (26) is particularly advantageous when a dispensing unit (22) with a long tubular portion and a floor dispensing head (22f), which opening (220) optionally remains close to the surface of the floor (1f) is used, as the efforts transmitted at the level of the coupling of the dispensing unit (22) with the dispensing opening (25o) increases with increasing length of the dispensing unit (22).

The robot (26) can also be used to increase the length of the tubular portion of the dispensing unit comprising a telescopic tubular portion or a bellow as illustrated in FIGS. 16(d) and 16(e) or to orient the opening (22o) of dispensing heads as illustrated in FIG. 16(c) or 16(d).

### METHOD FOR FORMING A WORKING LINING (2S) IN A TUNDISH (1)

Embodiments of the present invention also concerns a method for forming a working lining (2s) on a surface of a cavity in a tundish (1) having a longitudinal dimension (x1) measured along the longitudinal axis (X), a height (z1) measured along the vertical axis (Z) and a transverse dimension (y1) measured along the transverse axis (Y) and comprising a floor (1f) and peripheral walls (1w) defining the cavity, wherein advantageously X⊥Y⊥Z. The method comprises providing an installation as described supra with the following steps, illustrated in FIGS. 1 to 12, as follows.

FIGS. 1 to 12 are illustrated with an embodiment according to FIG. 17, wherein x1>y1, defining a frontal orientation. The longitudinal translation mechanism (31x) includes bearings or wheels (33) mounted on the tank (21) which roll on rails (34x) extending along the longitudinal direction (X). The installation comprises no dispensing transverse translation mechanism (31dy). It is clear that the steps defined below and illustrated in FIGS. 1 to 12 can easily be applied by a skilled person to any one of the installation configurations illustrated in FIGS. 17 to 23 and listed in Table 1.

First, the installation is set up to prepare for the coating operation. The tank (21) is first filled with an amount of coating composition in the form of dry particulate material (2p), the dispensing outlet (25o) being at a first position (X1) along the longitudinal axis. The amount of coating composition is advantageously sufficient to fully fill the floor gap and peripheral gap (111) to avoid having to interrupt the method to refill an empty tank (21).

The plunger (11) is loaded onto the elevation translation mechanism (31z) and translated (Δz) along a direction comprising a component parallel to the vertical axis (Z) to a top vertical position (Z0), higher than the height (z1) of the tundish.

As shown in FIGS. 1(a) and 1(b), the tundish (1) is loaded onto the transverse translation mechanism (31y) and translated (Δy) along the transverse axis (Y) to a first transverse position (Y1), below and in alignment with the dispensing outlet (25o).

A dispensing unit (22) is coupled to the dispensing outlet (25o). A floor dispensing head (22f) is optionally selected. The coupling can be performed manually by an operator, but it is optionally performed automatically by a robot (26). The installation is now ready for starting the coating operation.

The coating composition can now be metered to feed the dispensing outlet (25o) at a controlled flow rate, to dispense the particulate material to thus form a bed of particulate material (2p) on a surface of the floor (1f) of the cavity. Depending on the installation configuration, this operation can be carried out by any one of the following actions.
In a configuration as illustrated in FIGS. 2 and 3, longitudinally translating (Δx) along the longitudinal axis (X) the dispensing outlet (25o), or
In a configuration as illustrated in FIGS. 20 and 21, transversally translating (Δy) the tundish (1) along the transverse axis (Y), or
In a configuration as illustrated in FIGS. 22 and 23, transversally translating (Δy) the dispensing outlet (25o) along the transverse axis (Y).

The floor dispensing head (22f) is optionally configured for forming a bed of particulate material on the floor (1f) of predefined thickness in one or more translations, preferably in a single translation of the dispensing unit (22) relative to the floor (1f) of the tundish. Alternatively, more than one pass may be required to achieve the desired bed thickness. The surface of the particulate bed is optionally as smooth as possible. To this purpose, the floor dispensing head (22f) can be provided with a raking element (22r) as illustrated in FIG. 16(a). In case the floor (1f) of the tundish is not flat, and comprises steps, a dispensing unit (22) with a telescopic or bellow fitted tubular portion can be used to maintain a substantially constant distance between the opening (22o) and the floor surface during the translation of the former.

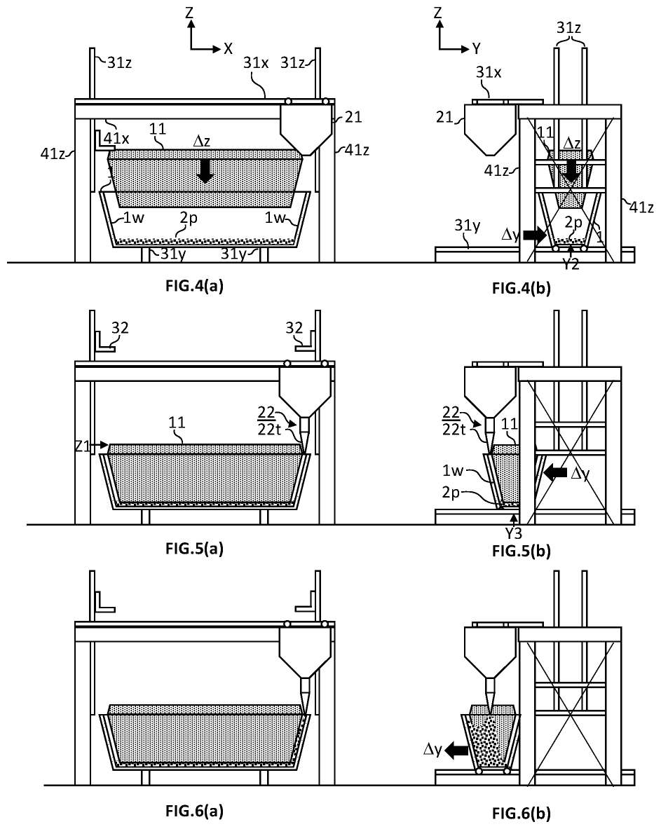

As shown in FIG. 4(b), the tundish (1) can be transversally translated (Δy) along the transverse axis (Y) into the passage, to a second transverse position (Y2), below and in alignment with the plunger (11). As shown in FIG. 4, the plunger (11) can thus be translated (Δz) along an elevation direction comprising a component parallel to the vertical axis (Z) to a bottom position (Z1) into the cavity until the plunger rests on the bed of particulate material and forms a peripheral gap with the peripheral walls of the tundish (1). In an advantageous embodiment, the plunger (11) is configured for vibrating to smoothen the surface of the particulate bed and ensure a continuous contact between the particulate bed and the plunger lower surface. The positioning of the plunger (11) in the cavity is controlled accurately to ensure that the peripheral gap (111) has the required gap width (g). To this purpose, an alignment system (4, 14) as described supra in reference to FIGS. 15(a) to 15(d) is optionally provided.

As illustrated in FIG. 5, the opening (22o) of a dispensing unit (22) is to be aligned with a point of the peripheral gap. The dispensing unit (22) is optionally a different one from the one used for forming the particulate bed on the floor (1f) of the tundish. The dispensing unit is optionally shorter than the former dispensing unit (22) and is equipped with a wall dispensing head (22w) as described supra, having an opening (22o) configured for pouring particulate material into the gap (111).

As shown in FIGS. 6 to 9, the coating composition is metered to feed the dispensing outlet (25o) at a controlled flow rate to dispense the particulate material. The opening (22o) of the dispensing unit (22) is driven along a whole perimeter of the peripheral gap (111) to fill the peripheral gap with particulate material (2p). This operation requires a synchronized combination of
a longitudinal translation (Δx) of the dispensing outlet (25o) along the longitudinal axis (X), and of
a transverse translation (Δy) along the transverse axis (Y) of either the tundish (1) or the dispensing outlet (25o).

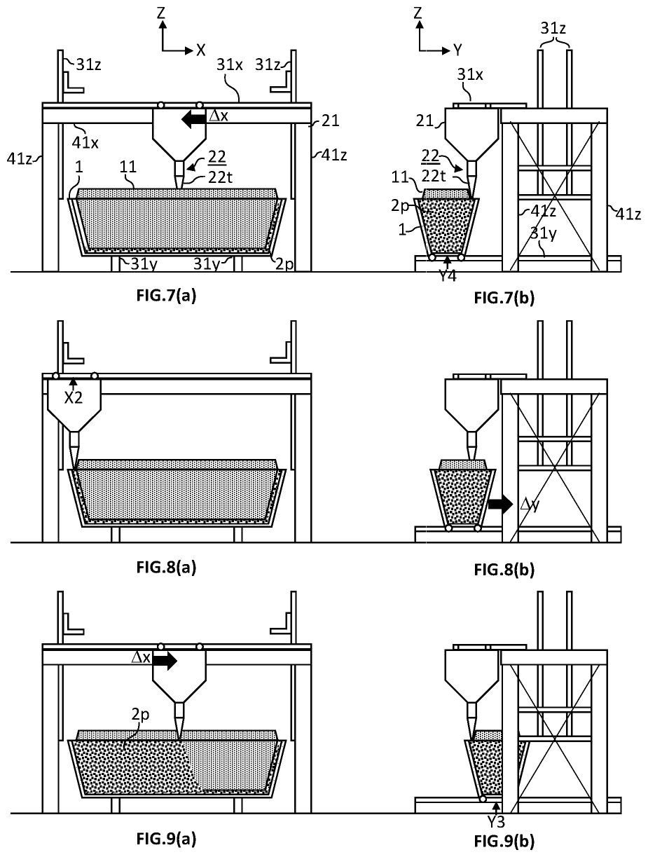

As shown in FIGS. 7, 9, and 17 to 20, the longitudinal portions of the peripheral gap (111) extending along the longitudinal axis (X) can be filled by longitudinally translating the dispensing outlet (25o) along the longitudinal axis (X) by driving the tank (21) mounted on bearings or wheels (33) along rails (34x). In these embodiments, the longitudinal dimension (x1) is optionally, albeit not necessarily, larger than the transverse dimension (y1). Alternatively, the longitudinal portions of the peripheral gap (111) can be spanned with a vario-length (e.g., telescopic) portion of the tubular portion separating the tank outlet (21o) from the dispensing outlet (25o), as shown in FIGS. 21 and 22. This embodiment is advantageous when the longitudinal dimension (x1) is smaller than the transverse dimension (y1). Instead of or concomitantly, the dispensing outlet (25o) can rotate about a vertical axis (Z) passing through the tank outlet (21o), as shown in FIGS. 23 and 25.

The transverse portions of the peripheral gap (111) extending along the transverse axis (Y) can be filled by transversally translating the tundish along the transverse axis (Y) by driving the tundish (1) mounted on bearings or wheels (33) along rails (34ty), as shown in FIGS. 6, 8, 17, 20, and 21.

Alternatively, the installation can comprise a dispensing transverse translation mechanism (31dy). In this case, the transverse portions of the peripheral gap (111) can be filled by transversally translating the dispensing outlet (25o) along the transverse axis (Y) by driving the tank (21) mounted on bearings or wheels (33) along rails (34dy). In this embodiment, illustrated in FIGS. 22 and 23, the longitudinal dimension (x1) is optionally smaller than the transverse dimension (y1). In case the longitudinal dimension (x1) is larger than the transverse dimension (y1), the transverse portion of the peripheral gap (111) can be filled by moving the dispensing outlet (25o) by means of a telescopic tubular portion as shown in FIG. 18 and/or by rotating the dispensing opening about a vertical axis (Z), as shown in FIGS. 19 and 25.

The coating composition thus filling the floor gap and peripheral gap (111) between the plunger (11) and the floor (1f) and peripheral walls (1w) of the tundish is allowed to solidify to form the working lining (2s), In case of a cold set composition, no particular action is required to solidify the lining. In case of heat-set compositions, heat is provided to the system. For example, the plunger (11) can be provided with heating elements (11h).

The tundish (1) can be transversally translated (Δy) along the transverse axis (Y) to the second position (Y2). As shown in FIG. 11, when the working lining (2s) is solid, the plunger (11) is coupled to the elevation translation mechanism (31z) and lifted up along the elevation direction to the top position (Z0) to remove the plunger from the cavity. To facilitate the extraction of the plunger out of the cavity and reduce adhesion of the plunger to the working lining (2s), the plunger can be vibrated. The tundish is now provided with a working lining (2s) as shown in FIGS. 12 (a), 12(b), and 15(a).

### INSTALLATION CONFIGURATIONS

FIGS. 17 to 23 illustrate a number of advantageous embodiments of the present invention. Table 1 summarizes the main features characterizing each embodiment. For sake of conciseness, rectangular tundishes are represented in FIGS. 17 to 23, with four corners numbers C1 to C4. FIGS. 17(a) and (b) to 23(a) and (b) show the dispensing opening (25o) positioned over corner C1, and FIGS. 17(c) and (d) to 23(c) and (d) represent the dispensing outlet (25o) positioned over the diagonally opposite corner (C3). The passage from corner (C1) to corner (C3) requires a longitudinal translation of the dispensing outlet (25o) along the longitudinal axis (X), from corner (C1) to corner (C2), and a transverse translation along the transverse axis (Y) from corner (C2) to corner (C3). Going from corner (C3) to corner (C1) requires a longitudinal translation of the dispensing outlet (25o) along the longitudinal axis (X), from corner (C3) to corner (C4), and a transverse translation along the transverse axis (Y) from corner (C4) back to corner (C1). The reverse trajectory (C1-C4-C3 followed by C3-C2-C1) is of course also possible. The two sets of Figures, with the dispensing outlet (25o) positioned over corner (C1) and corner (C3) therefore illustrate for each embodiment of FIGS. 17 to 23 the translation mechanisms required for driving the dispensing outlet (25o) around the whole perimeter of the peripheral gap (111).

Because the length to width aspect ratio (L/W) of a tundish is greater than 2, and can be greater than 3, 4, or even 5, the orientation of the tundish (1) relative to the installation is important. It can be seen that the orientation of the tundish (1) can vary by rotation thereof of 90° depending on whether,
the length of the tundish is positioned parallel to the longitudinal axis (X) and the width parallel to the transverse axis (Y), such that the longitudinal dimension (x1) corresponds to the length of the tundish (1) and the transverse dimension (y1) corresponds to the width thereof, i.e., x1>y1, as in embodiments 1 to 3 of Table 1, illustrated in FIGS. 17 to 19; this orientation is herein referred to as a “frontal orientation”, or
the length of the tundish is positioned parallel to the transverse axis (Y) and the width parallel to the longitudinal axis (X), such that the longitudinal dimension (x1) corresponds to the width of the tundish (1) and the transverse dimension (y1) corresponds to the length thereof, i.e., y1>x1, as in embodiments 4 to 7 of Table 1, illustrated in FIGS. 20 to 23; this orientation is herein referred to as a “lateral orientation”.

As discussed supra, the longitudinal translation mechanism can be based on,
the tank (21) mounted on bearings or wheels (33) rolling on rails (34x); this embodiment is advantageous when x1>y1 (=frontal orientation) as shown in FIGS. 17 to 19 (=embodiments #1 to 3 in Table 1), but can also be used with the other orientation (i.e., y1>x1) as illustrated in FIG. 20 (=embodiment #4 in Table 1),
a vario-length (e.g., telescopic) tubular portion between the tank outlet (21o) and the dispensing outlet (25o); this embodiment is advantageous when y1>x1 (=lateral orientation), as illustrated in FIGS. 21 and 22 (=embodiments #5 and 6 in Table 1), or
the rotation of the dispensing outlet (25o) about the tank outlet (21o); this embodiment is advantageous when y1>x1 (=lateral orientation), as illustrated in FIG. 23 (=embodiment #7 in Table 1).

The transverse translation mechanism (31y) is based on loading the tundish (1) on wheels (33) or bearings rolling on rails (34ty). The transverse translation mechanism (31y) can be used to drive the relative motion between the tundish and the dispensing unit along the transverse portions of the peripheral gap (111) as illustrated in FIGS. 17, 20, and 21 (=embodiments #1, 4, and 5 in Table 1). In this case, a dispensing transverse translation mechanism (31dy) is not essential.

Alternatively, the transverse translation mechanism (31y) can be used merely for driving the tundish below the plunger (11) before insertion thereof into the cavity and possibly for aligning the tundish with the dispensing outlet (25o). The relative motion of the dispensing unit (22) and tundish along the transverse direction is then ensured by the dispensing transverse translation mechanism (31dy), as illustrated in FIGS. 18, 19, 22 and 23 (=embodiments 2, 3, 6, and 7 in Table 1).

TABLE 1
Various embodiments of the installation of the present invention

| | | | | | Dispensing |
|---|---|---|---|---|---|
| | | | Longitudinal | Transverse | transverse |
| | | | translation | translation | translation |
| | | | mechanism | mechanism | mechanism |
| # | FIG. | orientation | (31x) | (31y) | (31dy) |
| 1 | 1-12, 17 | x1 > y1 | Tank 21 + | Rails 34ty | no |
| | | | rails 34x | | |
| 2 | 18 | x1 > y1 | Tank 21 + | Only for plunger | telescopic |
| | | | rails 34x | | |
| 3 | 19 | x1 > y1 | Tank 21 + | Only for plunger | rotation |
| | | | rails 34x | | |
| 4 | 20 | y1 > x1 | Tank 21 + | Rails 34ty | no |
| | | | rails 34x | | |
| 5 | 21 | y1 > x1 | Telescopic | Rails 34ty | no |
| 6 | 22 | y1 > x1 | Telescopic | Only for plunger | Tank 21 + |
| | | | | | rails 34dy |
| 7 | 23 | y1 > x1 | Rotation | Only for plunger | Tank 21 + |
| | | | | | rails 34dy |

The dispensing transverse translation mechanism (31dy) is essential only in case the transverse translation mechanism (31y) is used only for driving the tundish below the plunger for insertion thereof into the tundish cavity. Like the longitudinal translation mechanism (31x) described supra, the dispensing transverse translation mechanism (31dy) is used for driving the relative movement of the dispensing unit (22) and tundish (1) along the transverse direction, without translating the tundish (1). It can be based on,
the tank (21) mounted on bearings or wheels (33) rolling on rails (34dy); this embodiment is advantageous when y1>x1 (=lateral orientation) as shown in FIGS. 21 and 22 (=embodiments #6 and 7 in Table 1),
a vario-length (e.g., telescopic) tubular portion between the tank outlet (21o) and the dispensing outlet (25o); this embodiment is advantageous when x1>y1 (=frontal orientation), as illustrated in FIG. 18 (=embodiment #2 in Table 1), or
the rotation of the dispensing outlet (25o) about the tank outlet (21o); this embodiment is advantageous when x1>y1 (=frontal orientation), as illustrated in FIG. 19 (=embodiment #3 in Table 1).

The rotation of the dispensing outlet (25o) about the tank outlet (21o) actually translates the dispensing outlet (25o) along both longitudinal and transverse axes (X, Y). In the above, the rotation of the dispensing outlet (25o) about the tank outlet (21o) was assigned to the longitudinal or the dispensing transverse translation mechanism (31x, 31dy) depending on whether the rotation was used to drive the relative motion of the dispensing unit and tundish along the longitudinal or the transverse portions of the peripheral gap (111). For example, FIG. 23(e) shows that the rotation of the dispensing outlet (25o) is used to follow the longitudinal portions of the peripheral gap (111) and is therefore considered as forming part of the longitudinal translation mechanism (31x). By contrast, FIG. 19(e) shows that the rotation of the dispensing outlet (25o) is used to follow the transverse portions of the peripheral gap (111). It is therefore considered as forming part of the dispensing transverse translation mechanism (31dy). Other combinations of translation mechanisms are possible. For example, rotation of a vario-length (e.g., telescopic) tubular portion can be combined as shown in FIG. 25.

The installation of embodiments of the present invention is advantageous in that,
It allows a full automation of the lining operation of a tundish,.
It can be used for different tundishes having a variety of geometries, by simply programming accordingly the synchronization of the longitudinal and transverse translations of the dispensing unit relative to the tundish,
The footprint of the installation is minimal.

| Ref # | Definition |
|---|---|
| 1 | Tundish |
| 1f | Floor of the tundish |
| 1m | Metal casing of the tundish |
| 1w | Peripheral walls of the tundish |
| 2p | Particulate material |
| 2s | Working lining |
| 3i | Permanent insulating layer |
| 3r | Permanent refractory layer |
| 4 | Tundish element of the alignment system |
| 4i | Female inlet for receiving the male element |
| 5 | Centring element of the tundish with the carriage |
| 11 | Plunger |
| 11h | Heating element of plunger |
| 14 | Plunger element of the alignment system |
| 16 | Holding elements of the plunger |
| 21 | Tank |
| 21o | Tank outlet |
| 22 | Dispensing unit |
| 22b | Bellow |
| 22f | Floor dispensing head |
| 22o | Opening of dispensing heads |
| 22r | Raking element |
| 22w | Wall dispensing head |
| 23 | Rack for storing dispensing units |
| 25 | Metering unit |
| 25o | Dispensing outlet |
| 25s | Archimedes' screw |
| 31x | Longitudinal translation mechanism along the longitudinal axis (X) |
| 31y | Transverse translation mechanism along the Transverse axis (Y) |
| 31dy | Dispensing transverse translation mechanism |
| 31z | Elevation translation mechanism along the vertical axis (Z) |
| 32 | Gripping means for coupling the plunger to the elevation translation mechanism |
| 33 | Bearings or wheels |
| 34x | Rail belonging to the longitudinal translation mechanism (31x) |
| 34dy | Rail belonging to the transverse translation mechanism (31y) for translating the |
| | dispensing outlet |
| 34ty | Rail belonging to the transverse translation mechanism (31y) for translating the tundish |
| 35 | Centring element of the carriage with the tundish |
| 36 | Carriage |
| 41x | Support frame component extending along the longitudinal axis (X) |
| 41y | Support frame component extending along the transverse axis (Y) |
| 41z | Support frame component extending along the vertical axis (Z) |
| 111 | Peripheral gap |
| C1-C4 | Tundish corners 1 to 4 |
| X1 | First position along the longitudinal axis (X) of the dispensing outlet |
| X2 | Second position along the longitudinal axis (X) of the dispensing outlet |
| Y0 | Loading position along the transverse axis (Y) of the tundish |
| Y1-Y4 | 1^{st}, 2^{nd}, 3^{rd}, and 4^{th} positions along the transverse axis (Y) of the tundish |
| Z0 | Top position along the vertical axis (Z) of the plunger |
| Z1 | Bottom position along the vertical axis (Z) of the plunger |
| Δx, Δy, Δz | Translation along the longitudinal axis (X), transverse axis (Y) and vertical axis (Z) |

1. An installation for applying, in a 3D space reference system (X, Y, Z), wherein X is a longitudinal axis, Y is a transverse axis, the longitudinal axis X and the transverse axis Y being non parallel coplanar axes and defining a horizontal plane (X,Y), and Z is a vertical axis perpendicular to said horizontal plane (X, Y), a lining composition in the form of dry particulate material (2p) to form a working lining (2s) onto a surface of a cavity of a tundish (1) wherein the tundish has a longitudinal dimension (x1) measured along the longitudinal axis (X), a height (z1) measured along the vertical axis (Z) and a transverse dimension (y1) measured along the transverse axis (Y) and comprises a floor (1f) and peripheral walls (1w) defining the cavity, and wherein the installation comprises,
a support frame (41x-41z) defining a passage of breadth measured along the longitudinal axis (X) greater than the longitudinal dimension (x1) of the tundish, and a height larger than the height (z1) of the tundish,
a tank (21) configured for storing an amount of the dry particulate material (2p) and comprising a tank outlet (21o) coupled to a metering unit (25) configured for metering and conveying a defined amount of dry particulate material (2p) to a dispensing outlet (25o),
one or more dispensing units (22) equipped with a dispensing head (22f, 22w) and configured for being reversibly coupled to the dispensing outlet (25o), and comprising one or more openings (22o) configured for dispensing dry particulate material metered by the metering unit,
a plunger (11) configured for fitting in the cavity with a floor gap between the plunger (11) and floor (1f) and a peripheral gap (111) of gap width (g) between the plunger (11) and peripheral walls (1w) of the tundish corresponding to a desired thickness of the working lining (2s),
a longitudinal translation mechanism (31x) configured for holding and translating the dispensing outlet (25o) along the longitudinal axis (X) over a distance greater than or equal to the longitudinal dimension (x1) of the tundish (1), with the dispense outlet (25o) located above the height (z1) of the tundish (1),
a transverse translation mechanism (31y) configured for receiving the tundish (1) and translating the tundish (1) along the transverse axis (Y) in and out of the passage, the transverse translation mechanism (31y) being configured for transversally translating the tundish (1) from a loading position (Y0) separate from the support frame (41x-41z) into the passage, to a second transverse position (Y2), below and in alignment with the plunger (11), and
an elevation translation mechanism (31z) supported by the support frame and configured for reversibly holding the plunger (11) and translating the plunger (11) along a direction having a component parallel to the vertical axis (Z) in and out of the cavity when the tundish is located in the passage.

2. The installation according to claim 1, comprising a controller configured for controlling and optionally synchronizing, one or more of:
the metering unit (25),
the longitudinal translation of the dispensing outlet (25o) by the longitudinal translation mechanism (31x),
the transverse translation of the tundish (1) by the transverse translation mechanism (31y).

3. The installation according to claim 1, wherein the metering unit (25) comprises an Archimedes' screw (25s).

4. The installation according to claim 1, comprising a rack (23) storing one or more dispensing units.

5. The installation according to claim 1, comprising a transverse dispensing mechanism (31dy) configured for translating (Δy) the dispensing outlet along the transverse direction (Y) over a distance at least equal to the transverse dimension (y1) of the tundish (1).

6. The installation according to claim 4, including a floor dispensing head (22f), comprising one or more openings (22o) forming in combination an elongated slit, of length (l) of at least 50% of a width of the floor (1f), and configured for dispensing particulate material (2p) to form a bed of particulate material over a whole area of the floor (1f) in translations of one or more of the following,
one or more longitudinal translations (Δx) of the dispensing outlet (25o), when the longitudinal dimension (x1) of the tundish is larger than the transverse dimension (y1) thereof, or
one or more transverse translation (Δy) of the tundish (1), when the longitudinal dimension (x1) of the tundish is shorter than the transverse dimension (y1) thereof, or
one or more transverse translation (Δy) of the dispensing outlet (25o), when the installation comprises a transverse dispensing mechanism (31dy) according to claim 5, and when the longitudinal dimension (x1) of the tundish is shorter than the transverse dimension (y1) thereof.

7. The installation according to claim 4, including a wall dispensing head (22w), comprising an opening (22o) having a largest dimension along at least one of the longitudinal and transverse axes (X, Y) not exceeding the gap width (g) of the peripheral gap (111).

8. The installation according to claim 1, wherein the dispensing unit (22) comprises a tubular portion having a length that can be varied along an extension direction comprising a component parallel to the vertical axis (Z).

9. The installation according to claim 1, comprising a robot (26) configured for coupling and decoupling the dispensing unit (22) to and from the dispensing outlet (25o) and for preferably selecting one of one or more dispensing units (22) and removing it from a rack (23), as well as for storing a dispensing unit (22) into the rack (23) after decoupling it from the dispensing outlet (25o).

10. The installation according to the preceding claim 9 wherein the robot (26), is mounted on a robot translation mechanism, configured for translating the robot (26) along the longitudinal direction (X) or the transverse direction (Y), and wherein preferably, the translating of the robot (26) is synchronized with translations (Δx, Δy) of the dispensing outlet (25o), and the robot is configured for handling and holding the dispensing unit (22) coupled to the dispensing outlet (25o) during the translations (Δx, Δy) of the dispensing outlet (25o).

11. (canceled)

12. The installation according to claim 1, comprising an alignment system (4, 14) ensuring that the plunger fits in the cavity leaving the peripheral gap (111) of defined gap width (g), wherein the alignment system (4, 14) comprises one or more aligning units each comprising a first element fixed to the plunger and a second element fixed to the tundish, wherein the first and second elements comprise a male element fitting into a female element upon vertically translating the plunger into the cavity.

13. The installation according to claim 1, wherein the plunger (11) comprises heating elements (11h) for driving the solidification of heat-set particulate materials (2p) to form the working lining (2s).

14. The installation according to claim 1, wherein the transverse translation mechanism (31y) comprises two rails (34ty) extending along the transverse axis (Y) and a carriage (36) mounted on bearings or wheels (33) configured for rolling on the rails and for receiving the tundish (1), wherein preferably a first centring element (35) is fixed to the carriage and a second centring element (5) is fixed to the tundish, wherein the first and second elements comprise a male element fitting into a female element upon vertically translating the tundish onto the carriage (36) to ensure repeatability of a position of the tundish relative to the carriage (36).

15. A method for forming a working lining (2s) on a surface of a cavity in a tundish (1) having a longitudinal dimension (x1) measured along the longitudinal axis (X), a height (z1) measured along the vertical axis (Z) and a transverse dimension (y1) measured along the transverse axis (Y) and comprising a floor (1f) and peripheral walls (1w) defining the cavity, the method comprising,
providing an installation according to claim 1,
filling the tank (21) with an amount of coating composition in the form of dry particulate material (2p), the dispensing outlet (25o) being at a first position (X1) along the longitudinal axis,
loading the plunger (11) onto the elevation translation mechanism (31z) and translating (Δz) the plunger along a direction comprising a component parallel to the vertical axis (Z) to a top vertical position (Z0), higher than the height (z1) of the tundish,
loading the tundish (1) onto the transverse translation mechanism (31y) and translating (Δy) the tundish along the transverse axis (Y) to a first transverse position (Y1), below and in alignment with the dispensing outlet (25o),
coupling a dispensing unit (22) to the dispensing outlet (25o),
metering the coating composition to feed the dispensing outlet (25o) at a controlled flow rate, to dispense the particulate material to thus form a bed of particulate material (2p) on a surface of the floor (1f) of the cavity by,
longitudinally translating (Δx) the dispensing outlet (25o) along the longitudinal axis (X), and/or
transversally translating (Δy) the tundish (1) along the transverse axis (Y), or
transversally translating (Δy) the dispensing outlet (25o) along the transverse axis (Y),
transversally translating (Δy) the tundish (1) along the transverse axis (Y) into the passage, to a second transverse position (Y2), below and in alignment with the plunger (11),
translating (Δz) the plunger (11) along an elevation direction comprising a component parallel to the vertical axis (Z) to a bottom position (Z1) into the cavity until the plunger rests on the bed of particulate material and forms a peripheral gap of gap width (g) with the peripheral walls of the tundish (1),
aligning the opening (22o) of a dispensing unit (22), which can be same as or different from the dispensing unit (22) cited supra, with a point of the peripheral gap,
metering the coating composition to feed the dispensing outlet (25o) at a controlled flow rate to dispense the particulate material, and driving the opening (22o) of the dispensing unit (22) along a whole perimeter of the peripheral gap (111) to fill the peripheral gap with particulate material (2p), with a synchronized combination of
a longitudinal translation by longitudinally translating (Δx) the dispensing outlet (25o) along the longitudinal axis (X), and of
a transverse translation by either,
transversally translating (Δy) the tundish (1) along the transverse axis (Y), or
transversally translating (Δy) the dispensing outlet (25o) along the transverse axis (Y),
allowing the coating composition thus filling the floor gap and peripheral gap (111) between the plunger (11) and the floor (1f) and peripheral walls (1w) of the tundish to solidify to form the working lining (2s),
transversally translating (Δy) the tundish (1) along the transverse axis (Y) to the second position (Y2), and
coupling the plunger (11) to the elevation translation mechanism (31z) and lifting the plunger up along the elevation direction to the top position (Z0) to remove the plunger from the cavity.

16. The installation according to claim 2 wherein the elevation translation of the plunger (11) by the elevation translation mechanism (31z) functions such as to fill, on the one hand, the floor gap between the plunger (11) and floor (1f) and, on the other hand, the peripheral gap (111) between the plunger (11) and peripheral walls (1w) of the tundish, when the plunger is in the cavity.

17. The installation according to claim 3, wherein the longitudinal translation mechanism (31x) is configured for moving the tank (21) and metering unit (25) together with the dispensing outlet (25o).

18. The installation according to claim 4. wherein the one or more dispensing units are equipped with different dispensing heads (22f, 22w).

19. The installation according to claim 4, wherein the opening (22o) is orientable.
